(19) United States
(12) Patent Application Publication
(10) Pub. No.: US 2010/0046745 A1
(43) Pub. Date: Feb. 25, 2010

(54) ENCRYPTING APPARATUS, DECRYPTING APPARATUS, CRYPTOCOMMUNICATION SYSTEM, AND METHODS AND COMPUTER PROGRAM PRODUCTS THEREFOR

(75) Inventors: Yoshikazu Hanatani, Tokyo (JP); Kenji Ohkuma, Kanagawa (JP); Atsushi Shimbo, Tokyo (JP); Hirofumi Muratani, Kanagawa (JP); Taichi Isogai, Tokyo (JP); Yuichi Komano, Kanagawa (JP); Kenichiro Furuta, Tokyo (JP); Tomoko Yonemura, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/397,668

(22) Filed: Mar. 4, 2009

(30) Foreign Application Priority Data
Aug. 25, 2008 (JP) 2008-216015

(51) Int. Cl. H04L 9/06

(52) U.S. Cl. 380/30

(57) ABSTRACT

A decrypting apparatus that decrypts encrypted data that has been encrypted first data containing plain data, the encrypted data being represented by using an affine representation F_{p̂m}×F_{p̂m}̂*(where p: a prime number; m: a natural number; and ̂: exponentiation) obtains encrypted data represented in a vector format and a secret key corresponding to a public key and judges whether a vector component contained in the encrypted data is the affine representation F_{p̂m}×F_{p̂m}̂*. Further, based on the result of the judging process, the decrypting apparatus maps the vector component onto each of the members of an algebraic torus by forming a decompression map and decrypts the encrypted data mapped onto each of the members of the algebraic torus, by using the secret key, therefore obtains the plain data.

### CROSS-REFERENCE TO RELATED APPLICATIONS

This application is based upon and claims the benefit of priority from the prior Japanese Patent Application No. 2008-216015, filed on Aug. 25, 2008; the entire contents of which are incorporated herein by reference.

### BACKGROUND OF THE INVENTION

1. Field of the Invention

The present invention relates to an encrypting apparatus that encrypts plain data by using a public key encryption scheme, a decrypting apparatus that decrypts encrypted plain data by using a public key encryption scheme, a cryptocommunication system; and methods and computer program products therefor.

2. Description of the Related Art

Various encryption methods are used for protecting information that travels on communication paths. Examples of encryption methods include common key encryption schemes and public key encryption schemes. When a common key encryption scheme is used, it is necessary to share a key in advance with the communication partner. Thus, when a common key encryption scheme is used in communication with a large indefinite number of parties like the communication over the Internet, the sharing and the management of the keys require a lot of time and effort. On the other hand, public key encryption schemes are able to realize secure communication without having the keys shared in advance. Thus, public key encryption schemes are widely used as a basic technology to provide network security.

Currently, typical security parameters that are used in public key encryption schemes are 1024 bits to 2048 bits. Security parameters are the parameters that determine the size of the public keys and the size of encrypted data. Security parameters have impacts on the levels of security of encryption methods. The larger a security parameter is, the larger the size of the public key and the size the encrypted data become. The size of the security parameters that are considered to be difficult to decipher is becoming larger every year. The reason is that the capabilities of attackers have improved along with the development of computers. In public key encryption schemes, the size of the public key and the size of encrypted data are each a number of times larger than the size of the security parameter, although the sizes may vary depending on the particular encryption method being used. For this reason, the increase in the size of security parameters can be a problem for such apparatuses that do not have a large enough memory capacity or a large enough communication band.

To cope with this problem, methods for compressing the size of the public key and the size of encrypted data in public key encryption schemes have been proposed. An example of such methods is described in K. Rubin and A. Silverberg, “Torus-Based Cryptography”, CRYPTO 2003, Lecture Notes in Computer Science (LNCS) 2729, pp. 349-365, 2003 and Robert Granger, Dan Page, Martijn Stam: A Comparison of CEILIDH and XTR, Algorithmic Number Theory Symposium (ANTS) 2004, pp. 235-249. This method is based on the fact that, by using a sub-set called an algebraic torus within a set of numbers used in a public key encryption scheme, it is possible to represent the elements of the set by using a small number of bits. It is known that, when the value n indicating the degree of an extension field to which the algebraic torus belongs is at most the product of exponentiations of two prime numbers p and q where the product is expressed as l=(p̂m)*(q̂n), the compression ratio (=the number of bits before the compression/the number of bits after the compression) can be expressed as l/φ(l), where φ(•) denotes the Euler function. The symbol “̂” denotes exponentiation. For example, p̂m denotes the m′th power of p. The transformation to a representation having a small number of bits can be realized by a map ρ used for transforming an extension field representation into a projection representation and a map τ used for transforming a projection representation into an affine representation. A specific example in which encrypted data is compressed will be described below. A calculation is performed while encrypted data c that is in an extension field representation is used as an input, so that compressed encrypted data γ is obtained (see Expression 1 below).

τρ(c)=γ (1)

It is possible to obtain a representation with the original number of bits by calculating inverse maps of ρ and τ. In the following sections, the inverse map of ρ will be expressed as “ψ”, whereas the inverse map of τ will be expressed as “τ−1”. When γ is given as compressed encrypted data, a calculation is performed to obtain c (see Expression 2 below).

ψτ−1(γ)=c (2)

Also, the documents cited above present a method for forming compression maps 1 and 2 and decompression maps 1 and 2 as well as a method for forming a map ρ6 used for compressing an extension field representation into an affine representation and a map “ρ6−1” used for decompressing an affine representation into an extension field representation while using these compression maps and decompression maps. As for the compression map ρ6, a calculation is performed while an arbitrary member t of a torus T in an extension field representation within an extension field of degree six (hereinafter, the “degree six extension field”) F_{(p̂m)̂6} is used as an input, so that a tuple of elements of an affine representation F_{p̂m}×F_{p̂m}̂* is obtained (see Expression 3 below).

ρ6(t)=(a,b)εF_{—}{p̂m}×F_{—}{p̂m}̂* (3)

In Expression 3, the symbol “×” denotes a direct product. When A is a set, Âm is a direct product set of as many A's as m. For example, “Â4=A×A×A×A” is satisfied. More specifically, for example, “{0,1,2}̂2={(0,0),(0,1),(0,2),(1,0),(1,1),(1,2),(2,0),(2,1),(2,2)}” is satisfied. In the present example, F_{p̂m} is a degree m extension field of a prime field F_{p}. It is possible to represent the elements of F_{p̂m} as the elements of {0, . . . , p−1}̂m, by using a vector representation. F_{p̂m}̂* is a multiplicative group of F_{p̂m}. It is possible to represent the elements of F_{p̂m}̂* as the elements of {0, . . . , p−1}̂m\{0}̂m, by using a vector representation, where the symbol “\” denotes a subtraction between the sets.

As for the decompression map “ρ6−1”, a calculation is performed while (a, b)εF_{p̂m}×F_{p̂m}̂* is used as an input, so that the member t of the torus T in the extension field representation within the degree six extension field F_{(p̂m)̂6} is obtained (see Expression 4 below).

ρ−1(a,b)=tεT (4)

Further, in the document by Robert Granger, Dan page, Martijn Stam: A comparison of CEILIDH and XTR, ANTS 2004: pp. 235-249, a method for forming ρ, ψ, τ, and τ−1 that are described above is presented with respect to an extension field representation {0, . . . , p−1}̂(6*m), a projection representation {0, . . . , p−1}̂(6*m), and an affine representation F_{p̂m}×F_{p̂m}̂* of the elements of the torus in the degree six extension field of F_{p̂m}, so that the maps in Expressions 3 and 4 are formed based on the presented method. In this situation, the calculations for the extension field representation and the projection representation are both a calculation of F_{p̂(6*m)}. According to Non-patent Documents K. Rubin and A. Silverberg, “Torus-Based Cryptography” , CRYPTO 2003, LNCS 2729, pp. 349-365, 2003 and Robert Granger, Dan Page, Martijn Stam: A Comparison of CEILIDH and XTR. ANTS 2004: 235-249, the calculation of F_{p̂(6*m)} is realized as a calculation of F_{((p̂m)̂3)̂2}. It is not possible to calculate the elements in the affine representation.

Further, it is possible to verify whether x is an element of T by, for example, using either one of the two methods described below in the calculation in F_{p̂(6*m)}.
Method 1: Check to see if the result of raising the value to the (p̂(6*m)−1)/(p̂(3m)−1)′th power equals 1 and also the result of raising the value to the (p̂(6*m)−1)/(p̂(2m)−1)′th power equals 1.
Method 2: Check to see if the result of raising the value to the (p̂(2m)−p̂m+1)′th power equals 1.

An El Gamal encryption scheme that uses a discrete logarithm problem system (see, for example, Taher El Gamal: A public key cryptosystem and a signature scheme based on discrete logarithms, the Institute of Electrical and Electronics Engineers, Inc. [IEEE] Transactions on Information Theory 31(4): pp. 469-472 (1985)) and a Cramer-Shoup encryption scheme (see, for example, R. Cramer and V. Shoup, “A practical key cryptosystem provably secure against adaptive chosen ciphertext attack”, CRYPTO 1998, LNCS 1462, pp. 13-25, 1998; and V. Shoup, “ACE Encrypt: The Advanced Cryptographic Engine's Public Key Encryption Scheme”, “http://www.zurich.ibm.com/security/ace/ace-encrypt.pdf”, 2000) have the problem where the length of the key and the size of the encrypted data are large compared to the size of plain data that is encryptable. To cope with this problem, a method has been presented by which a public key and encrypted data are compressed so that the size thereof can be reduced, while making use of the notion that the public key and the encrypted data in the El Gamal encryption scheme configured in an algebraic torus are elements of an algebraic torus (see, for example, K. Rubin and A. Silverberg, “Torus-Based Cryptography”, CRYPTO 2003, LNCS 2729, pp. 349-365, 2003; Marten van Dijk, David P. Woodruff: Asymptotically Optimal Communication for Torus-Based Cryptography, CRYPTO 2004: pp. 157-178; and Marten van Dijk, Robert Granger, Dan Page, Karl Rubin, Alice Silverberg, Martijn Stam, David P. Woodruff: Practical Cryptography in High Dimensional Tori, EUROCRYPT 2005: pp. 234-250).

To realize encrypting processes and decrypting processes in a public key encryption scheme in a secure manner, it is necessary to verify whether the target of the process is an element of the group for which the encryption is defined. Also, in the compressing processes and the decompressing processes in an algebraic torus, if the target of the process is not an element of the group for which the encryption is defined, it is not possible to form the map correctly. However, in the existing encryption systems that use an algebraic torus like the ones presented in the following documents, it is necessary to consider at which point in time and in what way the input to the encrypting processes and the decrypting processes should be verified to determine whether the input is a member of the group for which the encryption is defined: K. Rubin and A. Silverberg, “Torus-Based Cryptography”, CRYPTO 2003, LNCS 2729, pp. 349-365, 2003; Marten van Dijk, David P. Woodruff: Asymptotically Optimal Communication for Torus-Based Cryptography, CRYPTO 2004: pp. 157-178; Marten van Dijk, Robert Granger, Dan Page, Karl Rubin, Alice Silverberg, Martijn Stam, David P. Woodruff: Practical Cryptography in High Dimensional Tori, EUROCRYPT 2005: pp. 234-250; and Robert Granger, Dan Page, Martijn Stam: A comparison of CEILIDH and XTR, ANTS 2004, pp. 235-249. For example, in the case where a compressing process and a decompressing process in an algebraic torus are simply combined with an encrypting process and a decrypting process in a public key encryption scheme, there is a possibility that the process to judge whether the input to each process is a member of the group for which the encryption is defined may include a redundant process. Thus, a method for judging, without performing any redundant processes, whether the input to an encrypting process or a decrypting process is a member of the group for which the encryption is defined has been in demand.

### SUMMARY OF THE INVENTION

According to one aspect of the present invention, a decrypting apparatus that decrypts encrypted data that is encrypted first data containing plain data, the encrypted data being represented by using an affine representation F_{p̂m}×F_{p̂m}̂* (where p: a prime number; m: a natural number; and ̂: exponentiation), the apparatus includes an obtaining unit that obtains encrypted data represented in a vector format and a secret key corresponding to a public key; a judging unit that judges whether a vector component contained in the encrypted data is the affine representation F_{p̂m}×F_{p̂m}̂*; a decompressing unit that, based on a result of the judging by the judging unit, maps the vector component onto each of members of an algebraic torus by forming a decompression map; and a decrypting unit that decrypts the encrypted data mapped onto each of the members of the algebraic torus, by using the secret key, therefore obtains the plain data.

According to another aspect of the present invention, an encrypting apparatus that encrypts plain data msg that is a member of an algebraic torus in a degree six extension field of F_{p̂m} and is represented by using an affine representation F_{p̂m}×F_{p̂m}̂* (where p: a prime number; and m: a natural number), the apparatus includes an obtaining unit that obtains the plain data msg and a public key, the plain data msg being a target of an encrypting process and being represented in a vector format; a judging unit that judges whether a vector component contained in the plain data msg is the affine representation F_{p̂m}×F_{p̂m}̂*; and an encrypting unit that, based on a result of the judging by the judging unit, encrypts the plain data msg by using the public key, and obtains encrypted data c that is represented by using a tuple of elements of an affine space F_{p̂m}×F_{p̂m}̂*.

According to still another aspect of the present invention, an encrypting apparatus that encrypts plain data msg that is a member of an algebraic torus in a degree six extension field of F_{p̂m} (where ̂ denotes exponentiation) and is represented by using an extension field representation {{0, . . . , p−1}̂(6*m)} (where p: a prime number; and m: a natural number), the apparatus includes an obtaining unit that obtains the plain data msg and a public key, the plain data msg being a target of an encrypting process; a judging unit that judges whether the plain data msg is a member of the algebraic torus by judging whether the plain data msg is contained in {0, . . . , p−1}̂(6*m) and whether msĝ(p̂(2*m)−p̂(m)+1)=1 is satisfied; an encrypting unit that, based on a result of the judging by the judging unit, encrypts the plain data msg by using the public key, and obtains encrypted data c that is represented by using a tuple of members of the algebraic torus; and a compressing unit that maps each of members of the encrypted data c into an affine representation F_{p̂m}×F_{p̂m}̂* by forming a compression map.

### BRIEF DESCRIPTION OF THE DRAWINGS

FIG. 1 is an exemplary diagram of a public key encryption scheme;

FIG. 2 is an exemplary diagram of a public key encryption scheme that uses a torus compression;

FIG. 3 is a conceptual drawing of processes performed in a Cramer-Shoup encryption scheme;

FIG. 4 is a conceptual diagram of a key generating apparatus 200 according to a first embodiment of the present invention;

FIG. 5 is a conceptual drawing of processes performed by an encrypting apparatus 301 and a compressing apparatus 302 in a torus compression Cramer-Shoup encryption scheme, according to the first embodiment;

FIG. 6 is a conceptual drawing of processes performed by a decrypting apparatus 401 and a decompressing apparatus 402 in a torus compression Cramer-Shoup encryption scheme, according to the first embodiment;

FIG. 7 is a flowchart of a procedure in a process in which a transmitting apparatus 300 encrypts and compresses plain data, according to the first embodiment;

FIG. 8 is a flowchart of a procedure in a process in which a receiving apparatus 400 decompress and decrypts compressed encrypted data that has been transmitted from the transmitting apparatus 300, according to the first embodiment;

FIG. 9 is a schematic drawing of a process for verifying, in the case where an encrypting process is simply combined with a compressing process, whether an input is a member of a proper group;

FIG. 10 is a schematic drawing of a process for verifying, in the case where a decompressing process is simply combined with a decrypting process, whether an input is a member of a proper group;

FIG. 11 is an exemplary diagram of a transmitting apparatus 300′ and a receiving apparatus 400′ according to a fifth embodiment of the present invention;

FIG. 12 is a flowchart of a procedure in a process in which the key generating apparatus 200 generates a public key and a secret key, according to the fifth embodiment;

FIG. 13 is a flowchart of a procedure in an encrypting process performed by the transmitting apparatus 300′, according to the fifth embodiment;

FIG. 14 is a flowchart of a procedure in a decrypting process performed by the receiving apparatus 400′, according to the fifth embodiment;

FIG. 15 is a flowchart of a procedure in an encrypting process performed by the transmitting apparatus 300′, according to a sixth embodiment of the present invention; and

FIG. 16 is a flowchart of a procedure in a decrypting process performed by the receiving apparatus 400′ according to the sixth embodiment.

### DETAILED DESCRIPTION OF THE INVENTION

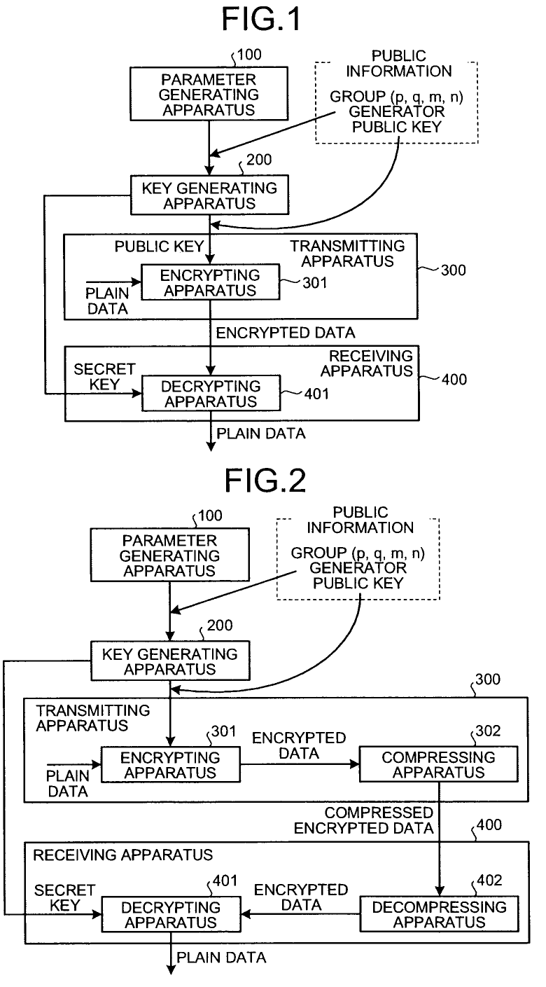

First, a public key encryption scheme according to a first embodiment of the present invention will be explained. FIG. 1 is an exemplary diagram of the public key encryption scheme. In the public key encryption scheme, a parameter generating apparatus 100 generates public information related to the public key encrypting process. Examples of the public information include information about elements of a group and hash functions, which are information related to the public key, as well as information about the order and the generator, which are information related to the group for which the encryption system is defined. Of the public information, the information related to the group can be expressed as {p, q, m, n}, when a Cramer-Shoup encryption scheme, which is explained later, is used. By using the public information, a key generating apparatus 200 generates a public key and a secret key that corresponds to the public key. A transmitting apparatus 300 includes an encrypting apparatus 301. The transmitting apparatus 300 receives, as an input, the public key that has been generated by the key generating apparatus 200 and plain data that is the target of an encrypting process. The plain data may be stored in the transmitting apparatus 300 in advance, may have been generated by the transmitting apparatus 300, may have been received from another communication apparatus, or may have been read from a storage medium. The encrypting apparatus 301 generates encrypted data by encrypting the plain data by using the public key and transmits the generated encrypted data to a receiving apparatus 400. The receiving apparatus 400 includes a decrypting apparatus 401. When having received the encrypted data, the receiving apparatus 400 decrypts the encrypted data by using the secret key that corresponds to the public key that has been used in the encrypting process of the encrypted data and thus obtains the plain data.

Next, a public key encryption scheme that uses a torus compression will be explained with reference to FIG. 2. In the public key encryption scheme that uses a torus compression, the transmitting apparatus 300 further includes a compressing apparatus 302, in addition to the encrypting apparatus 300. The receiving apparatus 400 further includes a decompressing apparatus 402, in addition to the decrypting apparatus 401. The configurations of the parameter generating apparatus 100 and the key generating apparatus 200 are the same as those described above. Thus, the explanation thereof will be omitted. The encrypting apparatus 301 generates encrypted data by encrypting plain data by using a public key, but performs this encrypting process by using a representation that is not compressed. The generated encrypted data is represented in a vector format. The compressing apparatus 302 compresses vector components contained in the encrypted data and outputs the compressed vector components. The transmitting apparatus 300 transmits the encrypted data that has been compressed (hereinafter, the “compressed encrypted data”) to the receiving apparatus 400. The decompressing apparatus 402 decompresses the vector components contained in the compressed encrypted data. The decrypting apparatus 401 decrypts the encrypted data by using the secret key that corresponds to the public key that has been used in the encrypting process of the decompressed encrypted data and thus obtains the plain data. In this situation, the decrypting apparatus 401 performs this decrypting process by using a representation that is not compressed. In the example shown in FIG. 2, the public key generating process and the secret key generating process performed by the key generating apparatus 200, the encrypting process performed by the encrypting apparatus 301, and the decrypting process performed by the decrypting apparatus 401 are performed through calculations that use an extension field representation.

Each of the apparatuses such as the parameter generating apparatus 100, the key generating apparatus 200, the transmitting apparatus 300, and the receiving apparatus 400 includes: a controlling device such as a Central Processing Unit (CPU) that exercises the overall control of the apparatus; storage devices such as a Read-Only Memory (ROM) and a Random Access Memory (RAM) that store therein various types of data and various types of computer programs (hereinafter, “programs”); external storage devices such as a Hard Disk Drive (HDD) and a Compact Disk (CD) drive device that store therein various types of data and various types of programs; a communication interface (I/F) that controls communication with external apparatuses; and a bus that connects these constituent elements to one another. Each of the apparatuses has a hardware configuration to which a commonly-used computer can be applied. The transmitting apparatus 300 and the receiving apparatus 400 perform communication while being connected together via a network (not shown) like the Internet. The encrypting apparatus 301 and the compressing apparatus 302 included in the transmitting apparatus 300 are realized when the CPU of the transmitting apparatus 300 executes the various types of programs stored in the storage devices and the external storage devices. Similarly, the decrypting apparatus 401 and the decompressing apparatus 402 included in the receiving apparatus 400 are realized when the CPU of the receiving apparatus 400 executes the various types of programs stored in the storage devices and the external storage devices.

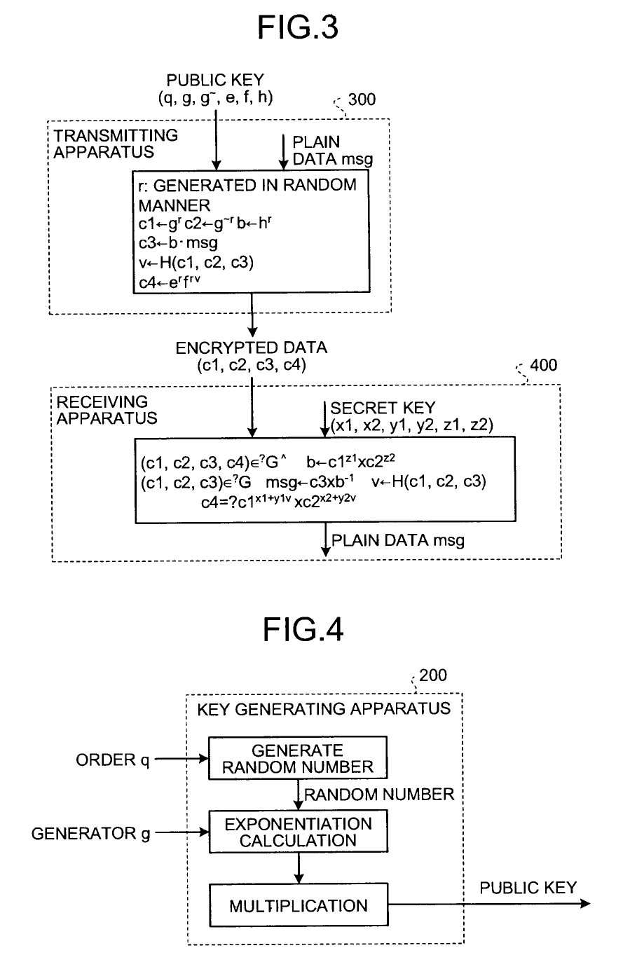

Next, a configuration in which a Cramer-Shoup encryption scheme is applied to the configurations of the transmitting apparatus 300 and the receiving apparatus 400 that are described in the public key encryption scheme will be explained. FIG. 3 is a conceptual drawing of processes performed in the Cramer-Shoup encryption scheme. The key generating apparatus 200 generates a public key (p, q, g, g˜, e, f, h). In the present example, p and q are each a prime number; p is the order of a group Ĝ, whereas q is the order of a subgroup G of the group Ĝ; g is the generator of the subgroup G (of order q) for which the encryption is defined; g˜, e, f, and h are also each a member of the group Ĝ. Plain data msg should also be a member of the subgroup G. On the other hand, the secret key (x1, x2, y1, y2, z1, z2) that corresponds to the public key is made up of either the integers from “1” to “q−1” or the integers from 0 to “q−1”. By using the public key, the encrypting apparatus 301 included in the transmitting apparatus 300 calculates encrypted data (c1, c2, c3, c4) that corresponds to the plain data msg. More specifically, by using q, the encrypting apparatus 301 generates a random number r that satisfies “0≦r<q−1”. Further, the encrypting apparatus 301 obtains c1 by calculating ĝr, c2 by calculating g˜̂r, and b by calculating ĥr. Also, the encrypting apparatus 301 obtains c3 by calculating b*m. The symbol “*” denotes a multiplication. Subsequently, the encrypting apparatus 301 obtains a hash value H(c1, c2, c3) by performing a calculation on (c1, c2, c3) while using a hash function. Further, the encrypting apparatus 301 obtains c4 by calculating êr*f̂r*v. As a result, the encrypting apparatus 301 obtains the encrypted data (c1, c2, c3, c4). The transmitting apparatus 300 transmits the obtained encrypted data (c1, c2, c3, c4) to the receiving apparatus 400.

On the other hand, when the receiving apparatus 400 has received the encrypted data (c1, c2, c3, c4), the decrypting apparatus 401 judges whether the plain data is proper based on the secret key (x1, x2, y1, y2, z1, z2) and the encrypted data (c1, c2, c3, c4). In the case where the result of the judging process is in the affirmative, the decrypting apparatus 401 calculates the plain data msg. More specifically, the decrypting apparatus 401 judges whether each of the elements of the encrypted data (c1, c2, c3, c4) is a member of the group Ĝ. In the case where the result of the judging process is in the affirmative, the decrypting apparatus 401 obtains b by calculating c1̂z1*c2̂z2. Subsequently, the decrypting apparatus 401 judges whether each of the elements of (c1, c2, c3) is a member of the subgroup G of the group Ĝ. Further, the decrypting apparatus 401 performs a calculation with a hash function while using the elements c1, c2, and c3 of the encrypted data and obtains a value used in a verification expression by performing an exponentiation calculation and a multiplication while using the elements c1 and c2 and the secret keys x1, x2, y1, and y2. After that, the decrypting apparatus 401 judges whether the verification expression shown as Expression 5 below is satisfied, in which the calculated value and the elements of the encrypted data are used. Further, the decrypting apparatus 401 performs an exponentiation calculation while using the elements c1 and c2 and the secret keys z1 and z2 and obtains an inverse element of the result of the exponentiation calculation. After that, the decrypting apparatus 401 decrypts the encryption that has been applied to the plain data msg by performing a multiplication while using the element c3.

c4=c1̂(x1+y1*v)*c2̂(x2+y2*v) (5)

Next, a Cramer-Shoup encryption scheme that uses a torus compression (hereinafter, a “torus compression Cramer-Shoup encryption scheme”) applied in the configuration described above will be explained. In the following example, the order of a torus in F_{p̂(6*m)} is a composite number. Plain data is represented in an extension field representation, whereas the calculation of the encrypted data is performed while using an extension field representation. The result of the calculation is compressed or decompressed by using an affine representation. In the present example, the group Ĝ for which the encryption is defined is a prime-number order subgroup (hereinafter, a “prime order subgroup”) G that is a subgroup of order q of an algebraic torus in a degree six extension field of F_{p̂m}. FIG. 4 is a conceptual diagram of the key generating apparatus 200 in the present configuration. The key generating apparatus 200 receives, as an input, the generator g of the prime order subgroup G of a composite-number order torus (hereinafter, a “composite order torus”) and the order q of the subgroup, each of which is the public information, and obtains a random number. The key generating apparatus 200 obtains a public key by performing an exponentiation calculation and a multiplication while using the obtained random number. Generally speaking, to calculate a public key in a Cramer-Shoup encryption scheme, both the exponentiation calculation and the multiplication are performed in a prime field. However, to calculate the public key in the torus compression Cramer-Shoup encryption scheme according to the first embodiment, the exponentiation calculation and the multiplication are performed in an extension field. When an algebraic torus in a degree six extension field is applied, calculations in the extension field F_{p̂(6*m)} are used for the calculations of the compression map, of the decompression map, and in the algebraic torus.

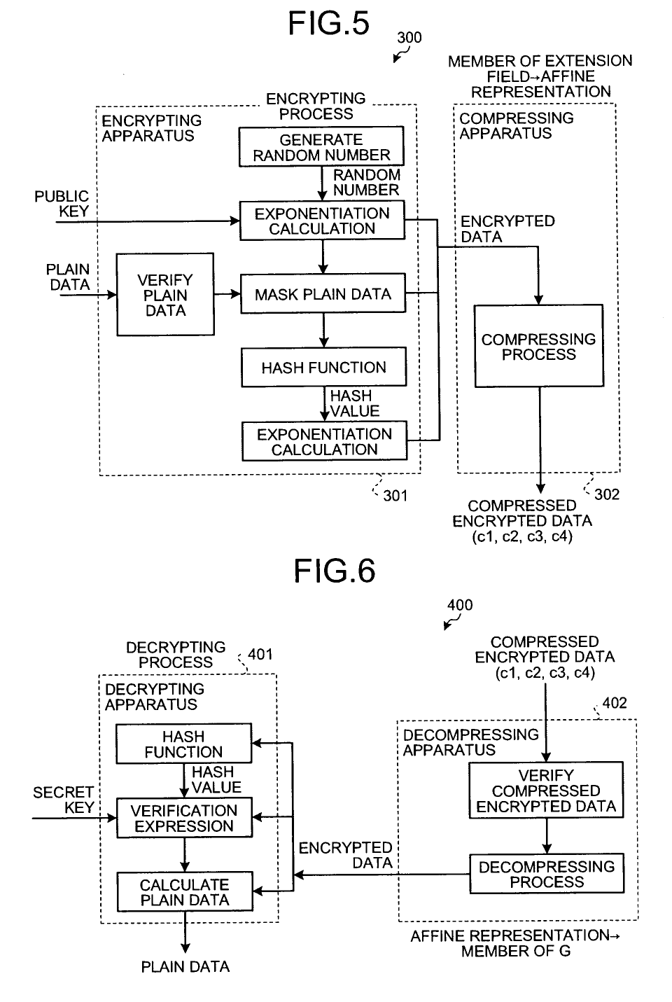

Next, the configurations of the encrypting apparatus 301 and the compressing apparatus 302 that are included in the transmitting apparatus 300 in the torus compression Cramer-Shoup encryption scheme will be explained. FIG. 5 is a conceptual drawing of the processes performed by the encrypting apparatus 301 and the compressing apparatus 302 in the torus compression Cramer-Shoup encryption scheme. The encrypting apparatus 301 receives, as an input, the public key that has been generated by the key generating apparatus 200, and also receives, as an input, the plain data msg that is the target of the encrypting process. It is assumed that the encrypting apparatus 301 processes plain data for each unit of msg that is represented by using the extension field representation {{0, . . . , p−1}̂(6*m)}. First, the encrypting apparatus 301 verifies whether the input plain data msg is a member of a proper group. The encrypting apparatus 301 performs this verification process by judging whether the plain data msg satisfies all of the conditions (A1), (B1_{—}1), and (B1_{—}2) that are shown below:
(A1): The plain data msg is contained in {0, . . . , p−1}̂(6*m);
(B1_{—}1): msĝ{p̂(2*m)−p̂(m)}=1 is satisfied in the calculation using the extension field representation;
(B1_{—}2): msĝ(q)=1 is satisfied in the calculation using the extension field representation.

In the case where the condition (A1) is satisfied, it means that the plain data msg is a member of the degree six extension field. In the case where the condition (B1_{—}1) is satisfied, it means that the plain data msg is a member of the composite order algebraic torus. In the case where the condition (B1_{—}2) is satisfied, it means that the plain data msg is a member of the prime order subgroup G that is a subgroup of order q of the composite order algebraic torus. The calculation to judge whether the condition (B1_{—}1) is satisfied can be performed efficiently. Thus, by performing this calculation before performing the calculation to judge whether the condition (B1_{—}2) is satisfied, it is possible to perform the verification process in an efficient manner. In the case where the result of the verification process using these conditions is in the affirmative, it means that the input plain data msg is represented by using the extension field representation {{0, . . . , p−1}̂(6*m)} and is a member of the prime order subgroup G of the composite order algebraic torus in the degree six extension field. In this situation, the encrypting apparatus 301 encrypts the plain data msg by using the public key. More specifically, as described in the explanation of the Cramer-Shoup encryption scheme, the encrypting apparatus 301 generates a random number and obtains the elements c1 and c2 of the encrypted data by performing an exponentiation calculation while using the generated random number as a multiplier, by using g˜, e, and f that are contained in the public key. Further, the encrypting apparatus 301 masks the plain data by performing a multiplication and obtains c3, which is another element of the encrypted data. Also, the encrypting apparatus 301 obtains a hash value by performing a hash calculation while using e and f that are contained in the public key and the random number. Further, by performing an exponentiation calculation while using the calculated hash value as a multiplier, the encrypting apparatus 301 obtains c4, which is another element of the encrypted data. The encrypted data is data that has been encrypted so as to contain the plain data msg that is the target of the decrypting process. These multiplication calculations are performed in the extension field F_p̂{(6*m)}. Subsequently, the compressing apparatus 302 compresses the elements c1, c2, c3, and c4 by forming a compression map and outputs compressed encrypted data (c1, c2, c3, c4). The compressed encrypted data that has been output is in an affine representation. The transmitting apparatus 300 transmits the output compressed encrypted data to the receiving apparatus 400.

Next, the configurations of the decrypting apparatus 401 and the decompressing apparatus 402 that are included in the receiving apparatus 400 in the torus compression Cramer-Shoup encryption scheme will be explained. FIG. 6 is a conceptual drawing of the processes performed by the decrypting apparatus 401 and the decompressing apparatus 402 in the torus compression Cramer-Shoup encryption scheme. The decompressing apparatus 402 receives, as an input, the compressed encrypted data (c1, c2, c3, c4) that has been transmitted from the transmitting apparatus 300. It is assumed that the decompressing apparatus 402 processes the data for each tuple of the affine representation F_{p̂m}×F_{p̂m}̂*. The decompressing apparatus 402 verifies whether each of the elements of the compressed encrypted data (c1, c2, c3, c4) is a member of a proper group. The decompressing apparatus 402 performs this verification process by judging whether each element ci of the compressed encrypted data satisfies both of the conditions (C1) and (D1) that are shown below:
(C1): The element ci is contained in F_{p̂m}×F_{p̂m}̂*;
(D1): cî(q)=1 is satisfied in the calculation using the extension field representation.

By performing the verification process under these conditions before forming a decompression map, it is possible to omit unnecessary calculations in the decompression map forming process. In the case where the condition (C1) is satisfied, it means that ci is represented by using the affine representation. In the case where the condition (D1) is satisfied, it means that ci is a member of the prime order subgroup G that is a subgroup of order q of the algebraic torus. Accordingly, in the case where the result of the verification process is in the affirmative, it means that the received compressed encrypted data (c1, c2, c3, c4) is encrypted data that is represented by using the affine representation F_{p̂m}×F_{p̂m}̂* and is a member of the subgroup G of the composite order algebraic torus in the degree six extension field of F_{p̂m}. In this situation, the decompressing apparatus 402 obtains the encrypted data (c1, c2, c3, c4) by decompressing, from the affine representation, the elements of the compressed encrypted data that has been mapped into the extension field representation in (D1), by forming a decompression map. The decrypting apparatus 401 receives the secret key, as an input. Further, as described in the explanation of the Cramer-Shoup encryption scheme, the decrypting apparatus 401 performs a calculation with a hash function while using the elements c1, c2, and c3 of the encrypted data and obtains the value used in the verification expression by performing an exponentiation calculation and a multiplication while using the elements c1 and c2 and the secret keys x1, x2, y1, and y2. After that, the decrypting apparatus 401 judges whether the verification expression in which the calculated value and the elements of the encrypted data are used is satisfied. Further, the decrypting apparatus 401 performs an exponentiation calculation while using the elements c1 and c2 and the secret keys z1 and z2 and obtains an inverse element of the result of the exponentiation calculation. After that, the decrypting apparatus 401 decrypts the encryption that has been applied to the plain data msg by performing a multiplication while using the element c3. As a result, the decrypting apparatus 401 obtains the plain data msg.

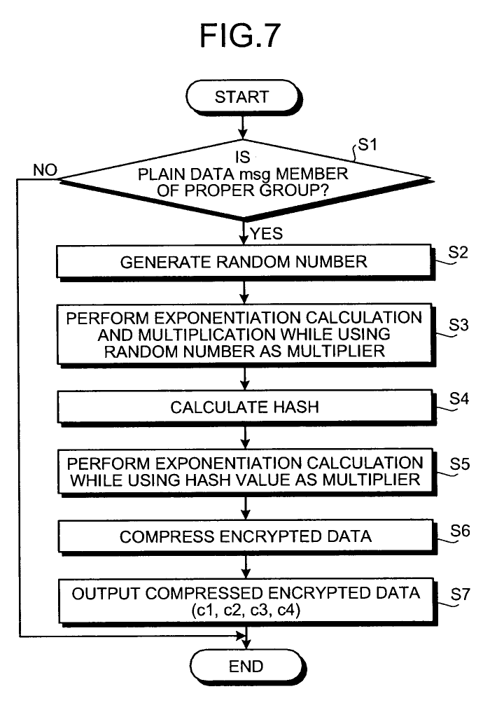

Next, a procedure in the process in which the transmitting apparatus 300 encrypts and compresses the plain data according to the first embodiment will be explained, with reference to FIG. 7. The encrypting apparatus 301 included in the transmitting apparatus 300 receives, as an input, the public key that has been generated by the key generating apparatus 200, and also receives, as an input, the plain data that is the target of the encrypting process. First, the encrypting apparatus 301 verifies whether the input plain data msg is a member of a proper group (Step S1). The encrypting apparatus 301 performs this verification process by judging whether the plain data msg satisfies all of the conditions (A1), (B1_{—}1), and (B1_{—}2) that are shown above. In the case where the result of the verification process at Step S1 is in the affirmative, as described in the explanation of the Cramer-Shoup encryption scheme, the encrypting apparatus 301 generates a random number (Step S2), performs an exponentiation calculation and a multiplication while using the generated random number as a multiplier, by using g˜, e, f that are contained in the public key (Step S3), and thus obtains c1 and c2, which are elements of the encrypted data. Further, the encrypting apparatus 301 masks the plain data by performing a multiplication and obtains c3, which is another element of the encrypted data. Also, the encrypting apparatus 301 obtains a hash value by performing a hash calculation while using e and f that are contained in the public key and the random number (Step S4). Further, the encrypting apparatus 301 performs an exponentiation calculation while using the calculated hash value as a multiplier (Step S5) and thus obtains c4, which is another element of the encrypted data. These multiplication calculations are performed in the extension field F_{p̂(6*m)}. After the encrypting apparatus 301 has performed the encrypting process in this manner, the compressing apparatus 302 performs a compressing process as described below. The compressing apparatus 302 compresses the encrypted data that has been generated as a result of the processes at Steps S2 through S5 by forming a compression map and generates compressed encrypted data (c1, c2, c3, c4) (Step S6). The compressing apparatus 302 then outputs the compressed encrypted data (Step S7). After that, the transmitting apparatus 300 transmits the compressed encrypted data that has been output at Step S6 to the receiving apparatus 400. On the contrary, in the case where the result of the verification process at Step S1 is in the negative, the encrypting apparatus 301 determines that an error has occurred and aborts the processes thereafter.

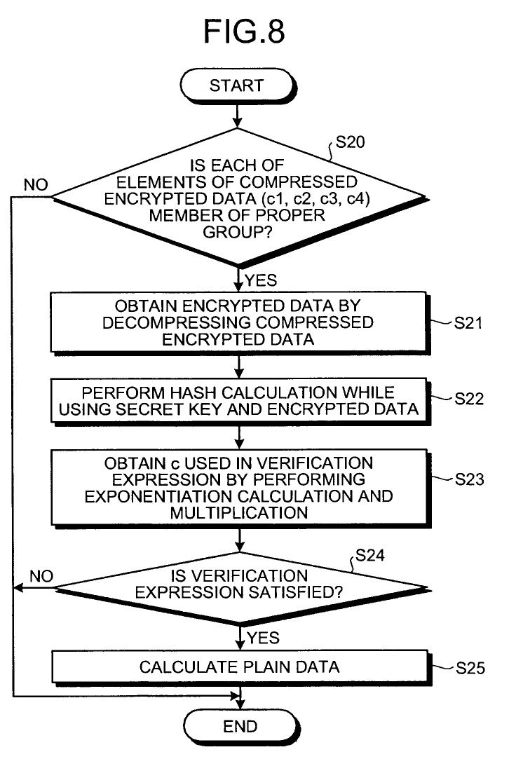

Next, a procedure in the process in which the receiving apparatus 400 decompresses and decrypts the compressed encrypted data that has been transmitted from the transmitting apparatus 300 according to the first embodiment will be explained, with reference to FIG. 8. The decompressing apparatus 402 included in the receiving apparatus 400 verifies whether each of the elements of the compressed encrypted data that has been transmitted from the transmitting apparatus 300 is a member of a proper group (Step S20). The decompressing apparatus 402 performs this verification process by judging whether each element ci of the compressed encrypted data satisfies both of the conditions (C1) and (D1) that are shown above. In the case where the result of the verification process at Step S20 is in the affirmative, the decompressing apparatus 402 decompresses the compressed encrypted data by forming a decompression map and thus obtains the encrypted data (c1, c2, c3, c4) (Step S21). After the decompressing apparatus 402 has performed the decompressing process in this manner, the decrypting apparatus 401 performs a decrypting process in the manner described below. The decrypting apparatus 401 receives the secret key as an input. The decrypting apparatus 401 performs a calculation with a hash function while using the elements c1, c2, c3 of the encrypted data that has been obtained at Step S21 (Step S22) and obtains a value used in the verification expression by performing an exponentiation calculation and a multiplication while using the elements c1 and c2 and the secret keys x1, x2, y1, and y2 (Step S23). After that, the decrypting apparatus 401 judges whether the verification expression shown as Expression 5 above is satisfied in which the calculated value and the elements of the encrypted data are used (Step S24). Further, in the case where the result of the judging process is in the affirmative, the decrypting apparatus 401 performs an exponentiation calculation while using the elements c1 and c2 and the secret keys z1 and z2 and obtains an inverse element of the result of the exponentiation calculation. After that, the decrypting apparatus 401 decrypts the encryption that has been applied to the plain data msg by performing a multiplication while using the element c3 (Step S25). As a result, the decrypting apparatus 401 obtains the plain data msg. On the contrary, in the case where the result of the verification process at Step S20 is in the negative, the decompressing apparatus 402 determines that an error has occurred and aborts the processes thereafter.

With the arrangements described above, in the case where the plain data is encrypted, and the encrypted data is compressed by the transmitted apparatus 300 so that the compressed encrypted data is decompressed and decrypted by the receiving apparatus 400, it is possible to omit the redundant process during the verification process to judge whether the plain data or the compressed encrypted data that has been input is a member of a proper group.

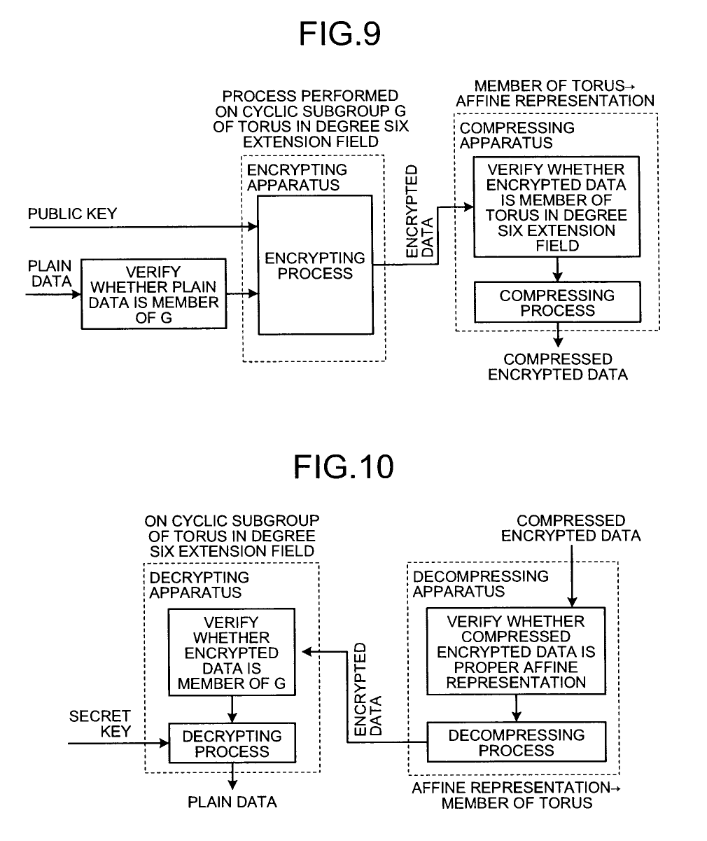

For example, in the case where an encryption system that uses a torus in the degree six extension field of F_{p̂m} and a compressing process are simply combined together, it is necessary to verify whether the input is a member of a proper group, not only before the encrypting process, but also before the compressing process, as shown in FIG. 9. According to the first embodiment, however, it is not necessary to perform this verification process before the compressing process. Thus, it is possible to omit the redundant process. Similarly, in the case where a decryption system that uses a torus in the degree six extension field of F_{p̂m} and a decompressing process are simply combined together, it is necessary to verify whether the input is a member of a proper group, not only before the decompressing process, but also before the decrypting process, as shown in FIG. 10. According to the first embodiment, however, it is not necessary to perform this verification process before the decrypting process. Thus, it is possible to omit the redundant process.

In other words, in the case where a prime order subgroup of a composite order torus is used in the encryption system like in the first embodiment, if the input plain data is a member of the composite order torus in the degree six extension field of F_{p̂m} and is also a member of the prime order subgroup, each of the elements of the encrypted data that is obtained as a result of the encrypting process is a member of the torus in the degree six extension field. Thus, it is not necessary to perform the verification process to verify whether the input is a member of the torus before the compressing process is performed. In addition, by performing, before the decompressing process, the verification process to verify whether each of the elements of the decompressed encrypted data is a member of the composite order torus in the degree six extension field and is also a member of the prime order subgroup, it is possible to identify improper encrypted data at the early stage. Thus, it is possible to reduce the processes that need to be performed when improper encrypted data has been input.

In the first embodiment described above, to verify whether the input plain data msg is a member of a proper group, the encrypting apparatus 301 performs the calculation to judge whether the condition (B1_{—}1) is satisfied before performing the calculation to judge whether the condition (B1_{—}2) is satisfied. It is a redundant process to verify whether the input is an element of the algebraic torus before performing the exponentiation calculation in which the order q of the subgroup is used as the exponent; however, with this arrangement, it is possible to achieve the advantageous effect of efficiently performing the verification process even in an environment where a large amount of improper plain data may be input. The reason can be explained as follows: With respect to an element x of F_{p̂m}, it is known that it is possible to efficiently calculate (x̂(p̂m)) by using a Frobenius map (see Henri Cohen, Gerhard Frey: Handbook of elliptic and hyperelliptic curve cryptography, Chapman & Hall/CRC). The order of a torus in the degree six extension field of F_{p̂m} is “p̂(2*m)−p̂(m)+1”. Thus, it is possible to efficiently calculate x̂{p̂(2*m)−p̂(m)+1} by using a Frobenius map raised to the (p̂m)′th power.

Next, an encrypting apparatus, a decrypting apparatus, an cryptocommunication system, and a method and a computer program product therefor according to a second embodiment of the present invention will be explained. Parts of the second embodiment that are the same as the first embodiment will be explained by using the same reference characters or will be omitted from the explanation.

In the first embodiment, the example is explained in which the prime order subgroup of the composite order torus is used in the encryption system. In the second embodiment, an example in which a prime-number order torus (hereinafter, a “prime order torus”) is used in the encryption system will be explained. More specifically, in the second embodiment, the order of the torus in F_{p̂(6*m)} is a prime number, whereas the plain data is represented in an extension field representation. The calculation of the encrypted data is performed by using an extension field representation, and the result of the calculation is compressed or decompressed while using an affine representation. In the present example, the group for which the encryption is defined is the prime order torus in the degree six extension field. The key generating apparatus 200 according to the second embodiment receives as an input, the generator g in a prime order torus and the order q thereof, each of which is the public information, and obtains a random number. The key generating apparatus 200 obtains a public key by performing an exponentiation calculation and a multiplication while using the obtained random number. According to the second embodiment, to calculate the public key, the exponentiation calculation and the multiplication are performed in an extension field, like in the first embodiment. When an algebraic torus in the degree six extension field of F_{p̂m} is applied, calculations in an extension field F_{p̂(6*m)} are used for the calculations of the compression map, of the decompression map, and in the algebraic torus.

Next, the configuration of the encrypting apparatus 301 included in the transmitting apparatus 300 according to the second embodiment that is different from that of the first embodiment will be explained. According to the second embodiment, to verify whether the input plain data msg is a member of a proper group, the encrypting apparatus 301 judges only whether the conditions (A1) and (B1_{—}1) are satisfied.

In the case where the result of the verification process is in the affirmative, it means that the input plain data msg is represented by using the extension field representation {{0, . . . , p−1}̂(6*m)} and is a member of the prime order algebraic torus in the degree six extension field of F_{p̂m}. In this situation, the encrypting apparatus 301 encrypts the plain data msg by using the public key, in the same manner as described in the first embodiment. The processes performed thereafter are the same as those according to the first embodiment.

Like the verification process according to the first embodiment, the verification process performed by the decompressing apparatus 402 is to verify whether the input is a member of a proper group. When the decompressing apparatus 402 verifies whether each of the elements of the compressed encrypted data that has been transmitted from the transmitting apparatus 300 is a member of a proper group, the decompressing apparatus 402 judges only whether the condition (C1) above is satisfied and does not judge whether the condition (D1) is satisfied.

In the case where the result of the verification process is in the affirmative, it means that the compressed encrypted data (c1, c2, c3, c4) that has been received is encrypted data that is represented by using the affine representation F_{p̂m}×F_{p̂m}̂* and is a member of the prime order algebraic torus in the degree six extension field of F_{p̂m}. In this situation, in the same manner as in the first embodiment, the decompressing apparatus 402 decompresses the compressed encrypted data by forming a decompression map and thus obtains the encrypted data. The processes performed thereafter are the same as the processes performed in the first embodiment.

As explained above, in the case where the prime order torus is used in the encryption system, it is possible to use all the elements of the prime order torus in the encryption system. Thus, only verifying whether each of the vector components of the plain data that is the target of the encryption is a member of the torus is sufficient. Thus, according to the second embodiment, it is not necessary to judge whether the condition (B1_{—}2) is satisfied and whether the condition (D1) is satisfied. Consequently, it is possible to make the processing load related to the verification process lighter than in the case where a prime order subgroup of a composite order torus is used.

Next, an encrypting apparatus, a decrypting apparatus, an cryptocommunication system, and a method and a computer program product therefor according to a third embodiment of the present invention will be explained. Parts of the third embodiment that are the same as the first embodiment or the second embodiment will be explained by using the same reference characters or will be omitted from the explanation.

In the first and the second embodiments, the example is explained in which the plain data is represented by using the extension field representation so that the calculation of the encrypted data is performed by using the extension field representation. According to the third embodiment, however, an example will be explained in which plain data is represented by using an affine representation so that the calculation of the encrypted data is performed by using a projection representation. In particular, in the following sections, an example will be discussed in which the order of the torus in F_{p̂(6*m)} is a composite number. More specifically, the order of the torus in F_{p̂(6*m)} is a composite number, whereas the plain data is represented in an affine representation, and the calculation of the encrypted data is performed by using a projection representation so that the result of the calculation is compressed or decompressed by using an affine representation. The group for which the encryption is defined is the prime order subgroup G that is a subgroup of order q of an algebraic torus in the degree six extension field of F_{p̂m}. The key generating apparatus 200 according to the third embodiment receives, as an input, the generator of a prime order cyclic subgroup of a composite order torus and the order q of the subgroup, each of which is the public information, and obtains a random number. The key generating apparatus 200 obtains a public key by performing an exponentiation calculation and a multiplication while using the obtained random number. According to the third embodiment, to calculate the public key, the exponentiation calculation and the multiplication are performed by using a projection representation. When an algebraic torus in a degree six extension field is applied, calculations that use a projection representation of the affine representation F_{p̂m}×F_{p̂m}̂* are used for the calculations of the compression map, of the decompression map, and in the algebraic torus.

Next, the configuration of the encrypting apparatus 301 included in the transmitting apparatus 300 according to the third embodiment that is different from that of the first embodiment will be explained. According to the third embodiment, it is assumed that the encrypting apparatus 301 processes the plain data for each unit of msg that is represented in the affine representation F_{p̂m}×F_{p̂m}̂*. The encrypting apparatus 301 judges whether the input plain data msg is a member of a proper member, by judging whether the plain data msg satisfies both of the conditions (A3) and (B3) shown below:
(A3): The plain data msg is contained in F_{p̂m}×F_{p̂m}̂*;
(B3): msĝ(q)=1 is satisfied in the calculation using the projection representation.

In the case where the condition (A3) is satisfied, it means that the plain data msg is represented by using the affine representation. In the case where the condition (B3) is satisfied, it means that the plain data msg is a member of the prime order subgroup G that is a subgroup of order q of the composite order algebraic torus in the degree six extension field of F_{p̂m}. Thus, in the case where the result of the verification process is in the affirmative, it means that the input plain data msg is represented by using the affine representation F_{p̂m}×F_{p̂m}̂* and is a member of the prime order subgroup G of the composite order algebraic torus in the degree six extension field. In this situation, in the same manner as described in the first embodiment, the encrypting apparatus 301 encrypts the plain data msg by using the public key. However, it should be noted that, as described above, the encrypting apparatus 301 performs the calculation in the algebraic torus by performing the calculation that uses the projection representation of the affine representation F_{p̂m}×F_{p̂m}̂* and obtains encrypted data that is represented by using a tuple of elements ci of an affine space F_{p̂m}×F_{p̂m}̂*. Also, in the same manner as described in the first embodiment, the compressing apparatus 302 compresses the encrypted data by forming a compression map and thus generates the compressed encrypted data (c1, c2, c3, c4); however, the compressing apparatus 302 forms the compression map by performing a calculation that uses a projection representation of the affine representation F_{p̂m}×F_{p̂m}̂*.

Next, the configuration of the decompressing apparatus 402 included in the receiving apparatus 400 according to the third embodiment that is different from that of the first embodiment will be explained. In the present example, the decompressing apparatus 402 verifies whether each of the elements of the compressed encrypted data that has been transmitted from the transmitting apparatus 300 is a member of a proper group by judging whether each element ci of the compressed encrypted data satisfies both of the conditions (C3) and (D3) shown below:
(C3): The element ci is contained in F_{p̂m}×F_{p̂m}̂*;
(D3): ĉ(q)=1 is satisfied in a calculation using the projection representation.

In the case where the condition (C3) is satisfied, it means that the element ci is represented by using the affine representation. In the case where the condition (D3) is satisfied, it means that the element ci is a member of the prime order subgroup G that is a subgroup of order q. Thus, in the case where the result of the verification process is in the affirmative, it means that the received compressed encrypted data (c1, c2, c3, c4) is encrypted data that is represented by using the affine representation F_{p̂m}×F_{p̂m}̂* and is a member of the prime order subgroup of the composite order algebraic torus in the degree six extension field of F_{p̂m}. In this situation, in the same manner as described in the first embodiment, the decompressing apparatus 402 decompresses the compressed encrypted data by forming a decompression map and thus obtains the encrypted data. In the present example, however, as described above, the decompressing apparatus 402 performs the calculations of the decompression map and in the algebraic torus by performing a calculation that uses a projection representation of the affine representation F_{p̂m}×F_{p̂m}̂*. The decrypting process performed by the decrypting apparatus 401 is the same as the process described in the first embodiment.

With the arrangements described above, even in the case where the plain data is represented by using the affine representation, and the calculation of the encrypted data is performed by using the projection representation, it is possible to omit the redundant process during the verification process to judge whether the input is a member of a proper group. In addition, because all the calculations are performed by using the projection representation, it is possible to omit the mapping process between the projection representation and the extension field representation and to configure the judging apparatus only with the mapping process between the affine representation and the projection representation.

Next, an encrypting apparatus, a decrypting apparatus, an cryptocommunication system, and a method and a computer program product therefor according to a fourth embodiment of the present invention will be explained. Parts of the fourth embodiment that are the same as any of the first to the third embodiments will be explained by using the same reference characters or will be omitted from the explanation.

In the description of the third embodiment, the example is explained in which the plain data is represented by using the affine representation, and the calculation of the encrypted data is performed by using the projection representation, while the order of the torus in the F_{p̂(6*m)} is a composite number. In the fourth embodiment, an example will be explained in which the order of the torus in F_{p̂(6*m)} is a prime number. More specifically, in the present example, the order of the torus in F_{p̂(6*m)} is a prime number, while the plain data is represented by using an affine representation, and the calculation of the encrypted data is performed by using a projection representation, so that the result of the calculation is compressed or decompressed by using an affine representation. The group for which the encryption is defined is the prime order torus in the degree six extension field of F_{p̂m}. The key generating apparatus 200 according to the fourth embodiment receives, as an input, the generator g in a prime order torus and the order q thereof, each of which is the public information, and obtains a random number. The key generating apparatus 200 obtains a public key by performing an exponentiation calculation and a multiplication while using the obtained random number. According to the fourth embodiment, to calculate the public key, the exponentiation calculation and the multiplication are performed by using a projection representation, like in the third embodiment. When an algebraic torus in a degree six extension field is applied, calculations that use a projection representation of the affine representation F_{p̂m}×F_{p̂m}̂* are used for the calculations of the compression map, of the decompression map, and in the algebraic torus.

Next, the configuration of the encrypting apparatus 301 included in the transmitting apparatus 300 according to the fourth embodiment that is different from that of the third embodiment will be explained. According to the fourth embodiment, when verifying whether the input plain data msg is a member of a proper group, the encrypting apparatus 301 judges only whether the condition (A3) above is satisfied and does not judge whether the condition (B3) above is satisfied. In the case where the result of the verification process is in the affirmative, it means that the input plain data msg is represented by using the affine representation F_{p̂m}×F_{p̂m}̂* and is a member of the prime order algebraic torus in the degree six extension field. In this situation, in the same manner as described in the first to the third embodiments, the encrypting apparatus 301 encrypts the plain data msg by using the public key. The processes that are performed thereafter are the same as those according to the first to the third embodiments.

Next, the configuration of the decompressing apparatus 402 included in the receiving apparatus 400 according to the fourth embodiment that is different from that of the third embodiment will be explained. According to the fourth embodiment, when verifying whether each of the elements of the compressed encrypted data that has been transmitted from the transmitting apparatus 300 is a member of a proper group, the decompressing apparatus 402 judges only whether the condition (C3) above is satisfied and does not judge whether the condition (D3) above is satisfied. In the case where the result of the verification process is in the affirmative, it means that the compressed encrypted data (c1, c2, c3, c4) that has been received is encrypted data that is represented by using the affine representation F_{p̂m}×F_{p̂m}̂* and is a member of the prime order algebraic torus in the degree six extension field of F_{p̂m}. In this situation, in the same manner as described in the first to the third embodiments, the decompressing apparatus 402 decompresses the compressed encrypted data by forming a decompression map and thus obtains the encrypted data. The processes performed thereafter are the same as those according to the first to the third embodiments.

With the arrangements described above, in the case where the plain data is represented by using the affine representation, and the calculation of the encrypted data is performed by using the projection representation, if the order of the torus in F_{p̂(6*m)} is a prime number, it is possible to make the processing load lighter than in the case where the order is a composite number. The reason is that, during the verification process to judge whether the input is a member of a proper group, it is not necessary to judge whether the condition (B3) is satisfied and whether the condition (D3) is satisfied.

Next, an encrypting apparatus, a decrypting apparatus, an cryptocommunication system, and a method and a computer program product therefor according to a fifth embodiment of the present invention will be explained. Parts of the fifth embodiment that are the same as any of the first to the fourth embodiments will be explained by using the same reference characters or will be omitted from the explanation.

According to the fifth embodiment, the order of the torus in F_{p̂(6*m)} is a composite number, whereas the order of the prime order subgroup of the torus is q. Also, the plain data is represented by using an affine representation, whereas the calculation of the encrypted data is performed by using a projection representation, so that the result of the calculation is compressed or decompressed by using an affine representation. The group for which the encryption is defined is the prime order subgroup G that is a subgroup of order q of an algebraic torus in the degree six extension field. The key generating apparatus 200 according to the fifth embodiment receives, as an input, the generator g of the prime order subgroup of the composite order torus and the order q of the subgroup, each of which is the public information, and obtains a random number. The key generating apparatus 200 obtains a public key by performing an exponentiation calculation while using the obtained random number. Further, the key generating apparatus 200 compresses the public key by forming a compression map and thus generates a compressed public key. According to the fifth embodiment also, to calculate the public key, the exponentiation calculation and the multiplication are performed by using a projection representation, like in the third and the fourth embodiments. When an algebraic torus in a degree six extension field is applied, calculations that use a projection representation of the affine representation F_{p̂m}×F_{p̂m}̂* are used for the calculations of the compression map, of the decompression map, and in the algebraic torus.

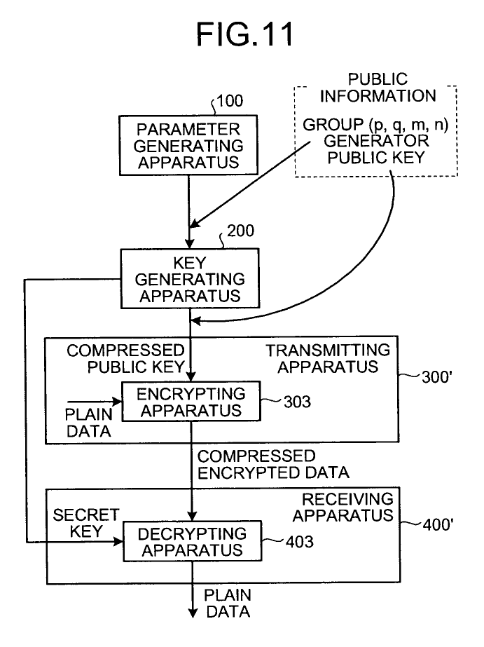

Next, the configuration of the transmitting apparatus 3001 according to the fifth embodiment will be explained, with reference to FIG. 11. According to the fifth embodiment, the transmitting apparatus 300′ includes an encrypting apparatus 303. The encrypting apparatus 303 receives, as an input, the compressed public key that has been generated by the key generating apparatus 200 and the plain data msg that is the target of the encrypting process. It is assumed that the encrypting apparatus 303 processes the plain data for each unit of msg that is represented by using a tuple of the affine representation F_{p̂m}×F_{p̂m}̂*. The encrypting apparatus 303 verifies whether the plain data msg is the affine representation F_{p̂m}×F_{p̂m}̂*. The encrypting apparatus 303 performs this verification process by judging whether the plain data msg satisfies all of the conditions (A5), (B5), and (C5) that are shown below:
(A5): With respect to each of the vector components in the vector representation of the plain data msg, each of the items from an item 1 to an item m is within the range from “0” to “p−1”;
(B5): With respect to each of the vector components in the vector representation of the plain data msg, each of the items from an item “m+1” to an item 2m is within the range from “0” to “p−1”, and also at least one of the items is not “0”; and
(C5): When the plain data msg is decompressed and transformed into a projection representation, the condition expression shown as Expression 6 below is satisfied in the calculation using the projection representation.

msĝ(q)=1 (6)

In the case where all the items satisfy the conditions (A5) and (B5), it means that the plain data msg is represented by using the affine representation. In the case where the condition (C5) is satisfied, it means that the plain data msg is a member of the prime order subgroup G that is a subgroup of order q of the composite order algebraic torus in the degree six extension field. Thus, in the case where the result of the verification process is in the affirmative, it means that the input plain data msg is represented by using the affine representation F_{p̂m}×F_{p̂m}̂* and is a member of the prime order subgroup G of the composite order algebraic torus in the degree six extension field. In this situation, the encrypting apparatus 303 decompresses the compressed public key and the generator and generates the encrypted data (c1, c2, c3, c4) by performing various types of processes such as performing an exponentiation calculation, forming a compression map, forming a decompression map, and performing a hash calculation. The encrypting apparatus 303 further generates compressed encrypted data (c1, c2, c3, c4) by compressing the generated encrypted data and outputs the compressed encrypted data that has been generated. The transmitting apparatus 300′ transmits the compressed encrypted data to a receiving apparatus 400′.

Next, the configuration of the receiving apparatus 400′ according to the fifth embodiment will be explained, with reference to FIG. 11. According to the fifth embodiment, the receiving apparatus 400′ includes a decrypting apparatus 403. The decrypting apparatus 403 receives, as an input, the secret key that has been generated by the key generating apparatus 200 and the compressed encrypted data that has been transmitted from the transmitting apparatus 300′. The decrypting apparatus 403 verifies whether each of the elements of the compressed encrypted data (c1, c2, c3, c4) is a member of F_{p̂m}×F_{p̂m}̂*. The decrypting apparatus 403 performs this verification process by judging whether each of the elements satisfies all of the conditions (D5), (E5), and (F5) that are shown below:
(D5): With respect to each of the vector components in the vector representation of ci (where i=1, 2, 3, and 4), each of the items from an item 1 to an item m is within the range from “0” to “p−1”;
(E5): With respect to each of the vector components in the vector representation of ci (where i=1, 2, 3, and 4), each of the items from an item “m+1” to an item 2m is within the range from “0” to “p−1”, and also at least one of the items is not “0” and
(F5): When each ci is decompressed and transformed into a projection representation, the condition expression 7 shown as Expression 7 below is satisfied in a calculation using the projection representation.

cîq=1 (7)

In the case where all the items of each element ci satisfy the conditions (D5) and (E5), it means that ci is represented by using the affine representation. In the case where each element ci satisfies the condition (F5), it means that the element ci is a member of the prime order subgroup G that is a subgroup of order q of the composite order algebraic torus in the degree six extension field. Thus, in the case where the result of the verification process is in the affirmative, it means that the compressed encrypted data (c1, c2, c3, c4) that has been received is encrypted data represented by using the affine representation F_{p̂m}×F_{p̂m}̂* and is a member of the prime order subgroup G that is a subgroup of order q of the composite order algebraic torus in the degree six extension field. In this situation, the decrypting apparatus 403 decrypts the encryption that has been applied to the plain data by using the secret key. More specifically, the decrypting apparatus 403 obtains the plain data by performing various types of processes such as performing a hash calculation, forming a compression map, performing a judging process while using the verification expression, and performing a calculation on the plain data.

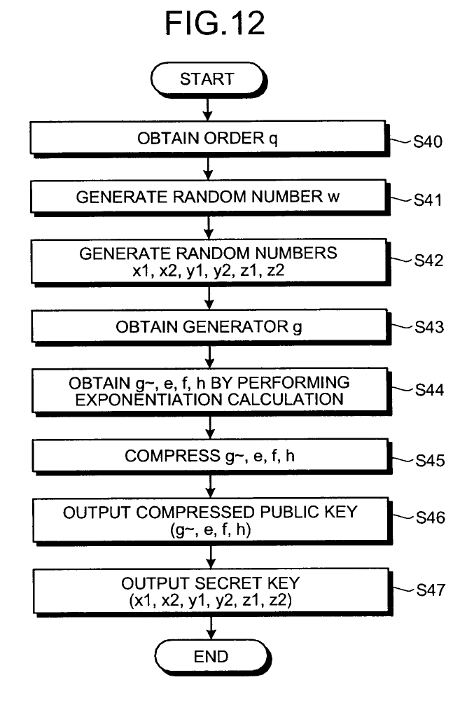

Next, a procedure in the process in which the key generating apparatus 200 generates the public key and the secret key according to the fifth embodiment will be explained, with reference to FIG. 12. The key generating apparatus 200 obtains a public parameter q as the order of the composite order algebraic torus in the degree six extension field, the public parameter q being contained in the public information generated by the parameter generating apparatus 100 (Step S40). Subsequently, the key generating apparatus 200 generates a random number w that satisfies “0<w<q” by using the obtained public parameter q (Step S41). Also, the key generating apparatus 200 generates random numbers x1, x2, y1, y2, z1, z2 that satisfy “0≦x1, x2, y1, y2, z1, z2<q”, by using the public parameter q (Step S42). Further, the key generating apparatus 200 obtains the generator g of the prime order torus, the generator g being contained in the public information (Step S43). After that, the key generating apparatus 200 performs exponentiation calculations by using Expressions 8 to 11 shown below (Step S44).

g˜=ĝw (8)

e=ĝ(x1+w*x2) (9)

f=ĝ(y1+w*y2) (10)

h=ĝ(z1+w*z2) (11)

After that, the key generating apparatus 200 compresses g˜, e, f, and h into an affine representation by forming a compression map (Step S45). Subsequently, the key generating apparatus 200 outputs (g˜, e, f, h) as a compressed public key (Step S46). Also, the key generating apparatus 200 outputs (x1, x2, y1, y2, z1, z2) as a secret key (Step S47).

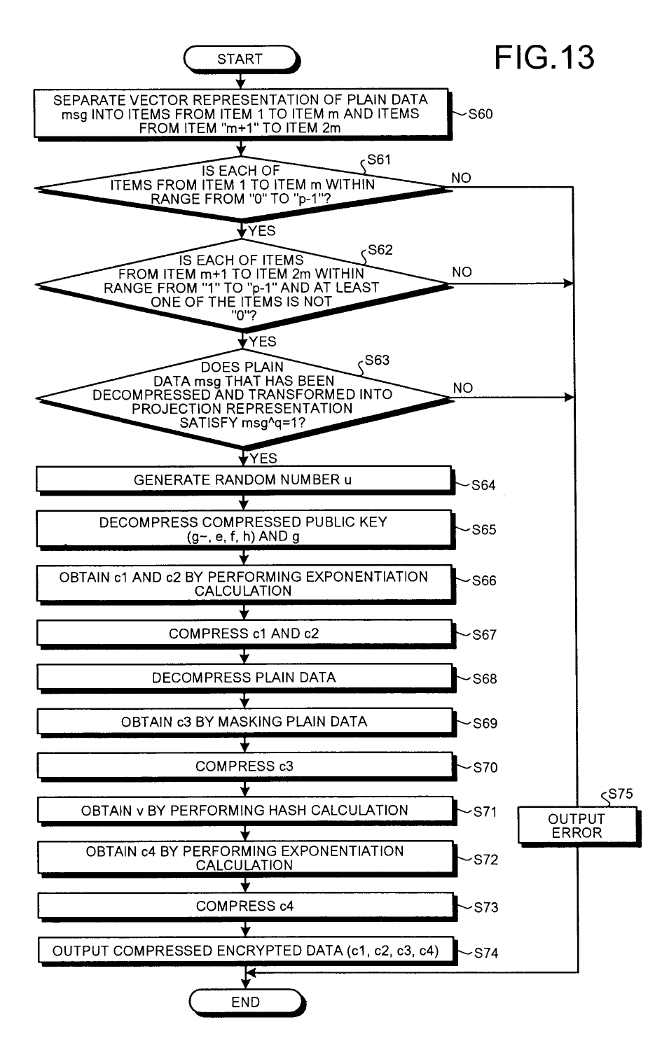

Next, a procedure in the encrypting process performed by the transmitting apparatus 300′ according to the fifth embodiment will be explained, with reference to FIG. 13. It is assumed that the encrypting apparatus 303 included in the transmitting apparatus 300′ has obtained, in advance, the compressed public key (g˜, e, f, h) that has been generated by the key generating apparatus 200 and the plain data msg that is the target of the encrypting process. The encrypting apparatus 303 verifies whether the plain data msg is a member of F_{p̂m}×F_{p̂m}̂*. More specifically, first, the encrypting apparatus 303 separates the vector components of the vector representation of the plain data msg into a section of items from an item 1 to an item m and another section of items from an item “m+1” to an item 2m (Step S60). After that, the encrypting apparatus 303 judges whether all of the conditions (A5), (B5), and (C5) shown above are satisfied (Steps S61 through S63).

In the case where at least one of the results of the judging processes at Steps S61, S62, and S63 is in the negative, the encrypting apparatus 303 outputs an error and aborts the processes thereafter (Step S75). In the case where all of the results of the judging processes at Steps S61, S62, and S63 are in the affirmative, the process proceeds to Step S64 where the encrypting apparatus 303 generates a random number u that satisfies “0≦u<q”, by using the public parameter q that is contained in the public information. After that, the encrypting apparatus 303 decompresses the compressed public key (g˜, e, f, h) and the generator g with a projection representation by forming a decompression map (Step S65). Subsequently, the encrypting apparatus 303 performs exponentiation calculations that use a projection representation while using Expressions 12 and 13 shown below and thus obtains c1 and c2 (Step S66).

c1=ĝu (12)

c2=(g˜)̂u (13)

After that, the encrypting apparatus 303 compresses c1 and c2 into an affine representation by forming a compression map (Step S67). Subsequently, the encrypting apparatus 303 decompresses the plain data msg into a projection representation by forming a decompression map (Step S68). After that, the encrypting apparatus 303 masks the plain data by performing an exponentiation calculation that uses a projection representation while Expression 14 below and thus obtain c3 (Step S69).

c3=msg*ĥu (14)

After that, the encrypting apparatus 303 compresses c3 by forming a compression map (Step S70). Subsequently, the encrypting apparatus 303 obtains a hash value from (c1, c2, c3) by performing a hash calculation and defines the obtained hash value as v (Step S71). After that, the encrypting apparatus 303 performs an exponentiation calculation by using Expression 15 below and thus obtains c4 (Step S72).

c4=ê(u)*f̂(u*v) (15)

After that, the encrypting apparatus 303 compresses c4 by forming a compression map (Step S73). Subsequently, the encrypting apparatus 303 outputs (c1, c2, c3, c4) as compressed encrypted data (Step S74). After that, the transmitting apparatus 300′ transmits the compressed encrypted data to the receiving apparatus 400′.

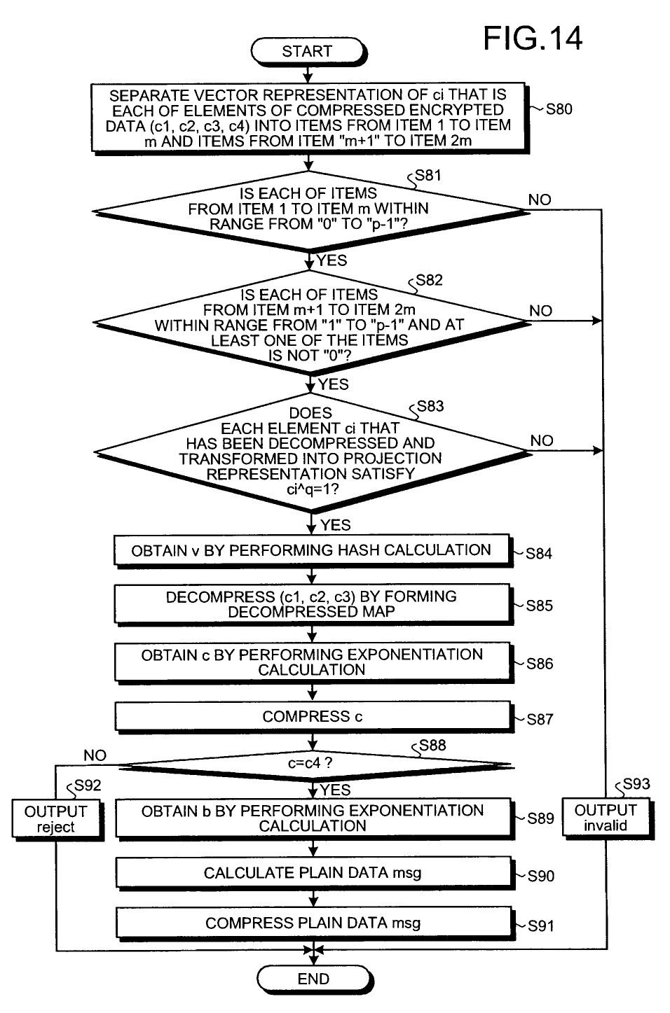

Next, a procedure in the decrypting process performed by the receiving apparatus 400′ according to the fifth embodiment will be explained, with reference to FIG. 14. It is assumed that the decrypting apparatus 403 included in the receiving apparatus 400′ has obtained, in advance, the secret key (x1, x2, y1, y2, z1, z2) that has been generated by the key generating apparatus 200. The decrypting apparatus 403 verifies whether each of the elements of the compressed encrypted data (c1, c2, c3, c4) is a member of F_{p̂m}×F_{p̂m}̂*. More specifically, the decrypting apparatus 403 separates the vector components of the vector representation of ci (where i=1, 2, 3, and 4) into a section of items from an item 1 to an item m and another section of items from an item “m+1” to an item 2m (Step S80). After that, the decrypting apparatus 403 judges whether all of the conditions (D5), (E5), and (F5) shown above are satisfied (Steps S81 through S83).

In the case where all of the results of the judging processes at Steps S81, S82, and S83 are in the affirmative, the process proceeds to Step S84 where the decrypting apparatus 403 obtains a hash value from (c1, c2, c3) by performing a hash calculation and defines the obtained hash value as v. After that, the decrypting apparatus 403 decompresses (c1, c2, c3) by forming a decompression map (Step S85). Subsequently, the decrypting apparatus 403 performs an exponentiation calculation with a projection representation by using Expression 16 below and thus obtains c that is used in a verification expression (Step S86).

c=c1̂(x1+y1*v)*c2̂(x2+y2*v) (16)

Subsequently, the decrypting apparatus 403 compresses c into an affine representation by forming a compression map (Step S87). After that, the decrypting apparatus 403 judges whether the verification expression “c=c4” is satisfied (Step S88). The decrypting apparatus 403 performs this judging process by, for example, judging whether the values of the vector components in the vector representations of c and c4 match. In the case where the result of the judging process is in the affirmative, the decrypting apparatus 403 performs an exponentiation calculation that uses a projection representation while using Expression 17 below and thus obtains b (Step S89).

b=c1̂z1*c2̂z2 (17)

Subsequently, the decrypting apparatus 403 calculates the plain data msg by using Expression 18 shown below (Step S90).

msg=c3*b̂(−1) (18)

After that, the decrypting apparatus 403 compresses the plain data msg into an affine representation by forming a compression map (Step S91) and outputs the result. On the contrary, in the case where the result of the judging process at Step S88 is in the negative, the decrypting apparatus 403 outputs a message indicating “reject” and aborts the processes thereafter (Step S92). In the case where any of the results of the judging processes at Steps S81 through S83 is in the negative, the decrypting apparatus 403 outputs a message indicating “invalid” and aborts the processes thereafter (Step S93). However, in any of these situations, another arrangement is acceptable in which the decrypting apparatus 403 ends the process without outputting anything.

With the arrangements described above, even in the case where the order of the torus in F_{p̂(6*m)} is a composite number, whereas the plain data is represented by using the affine representation, and the calculation of the encrypted data is performed by using the projection representation, it is possible to omit the redundant process during the verification processes to judge whether the input is a member of a proper group.

Next, an encrypting apparatus, a decrypting apparatus, an cryptocommunication system, and a method and a computer program product therefor according to a sixth embodiment of the present invention will be explained. Parts of the sixth embodiment that are the same as any of the first to the fifth embodiments will be explained by using the same reference characters or will be omitted from the explanation.

According to the sixth embodiment, the order of a torus in F_{p̂(6*m)} is the prime number q, whereas the plain data is represented by using an affine representation, and the calculation of the encrypted data is performed by using a projection representation, so that the result of the calculation is compressed or decompressed by using an affine representation. In the present example, the group for which the encryption is defined is the prime order torus in the degree six extension field. The configuration of the key generating apparatus 200 according to the sixth embodiment is the same as the configuration according to the fifth embodiment.

The configuration of an encrypting apparatus 303′ included in the transmitting apparatus 300′ according to the sixth embodiment that is different from the configuration of the encrypting apparatus 303 according to the fifth embodiment can be explained as follows: When verifying whether the plain data is a member of F_{p̂m}×F_{p̂m}̂*, the encrypting apparatus 303′ according to the sixth embodiment judges only whether the conditions (A5) and (B5) are satisfied and does not judge whether the condition (C5) is satisfied. In the case where the result of the verification process is in the affirmative, it means that the input plain data msg is represented by using the affine representation F_{p̂m}×F_{p̂m}̂* and is a member of the prime order algebraic torus in the degree six extension field. In this situation, the encrypting apparatus 303′ generates the compressed encrypted data (c1, c2, c3, c4) in the same manner as described in the fifth embodiment. The processes thereafter are the same as the processes performed in the fifth embodiment.

The configuration of a decrypting apparatus 403′ included in the receiving apparatus 400′ according to the sixth embodiment that is different from the configuration of the decrypting apparatus 403 according to the fifth embodiment can be explained as follows: When verifying whether the compressed encrypted data is a member of the group for which the encryption is defined, the decrypting apparatus 403′ judges only whether the conditions (D5) and (E5) are satisfied and does not judge whether the condition (F5) is satisfied. In the case where the result of the verification process is in the affirmative, it means that the compressed encrypted data (c1, c2, c3, c4) that has been received is encrypted data that is represented by using the affine representation F_{p̂m}×F_{p̂m}̂* and is a member of the prime order algebraic torus in the degree six extension field. In this situation, the decrypting apparatus 403′ decrypts the encryption that has been applied to the plain data by using the secret key, in the same manner as described in the fifth embodiment.

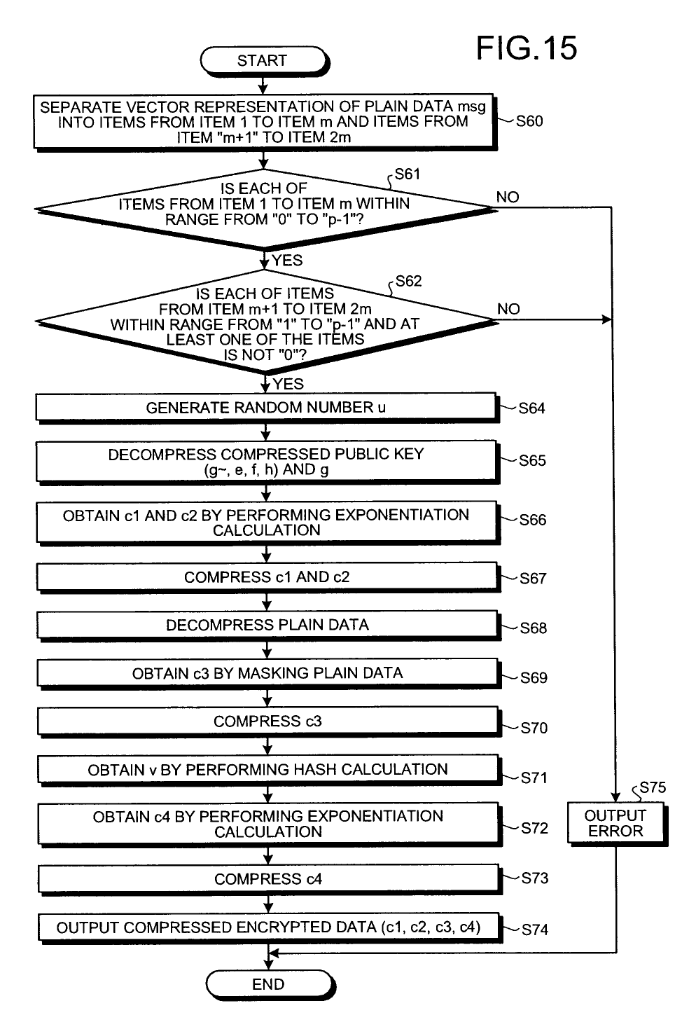

Next, a procedure in the encrypting process performed by the transmitting apparatus 300′ according to the sixth embodiment will be explained, with reference to FIG. 15. The processes performed at Steps S60 through S62 are the same as the processes according to the fifth embodiment. In the case where the result of the judging process at Step S62 is in the affirmative, the encrypting apparatus 303′ does not perform the process at Step S63 but performs the processes at Step S64 and thereafter.

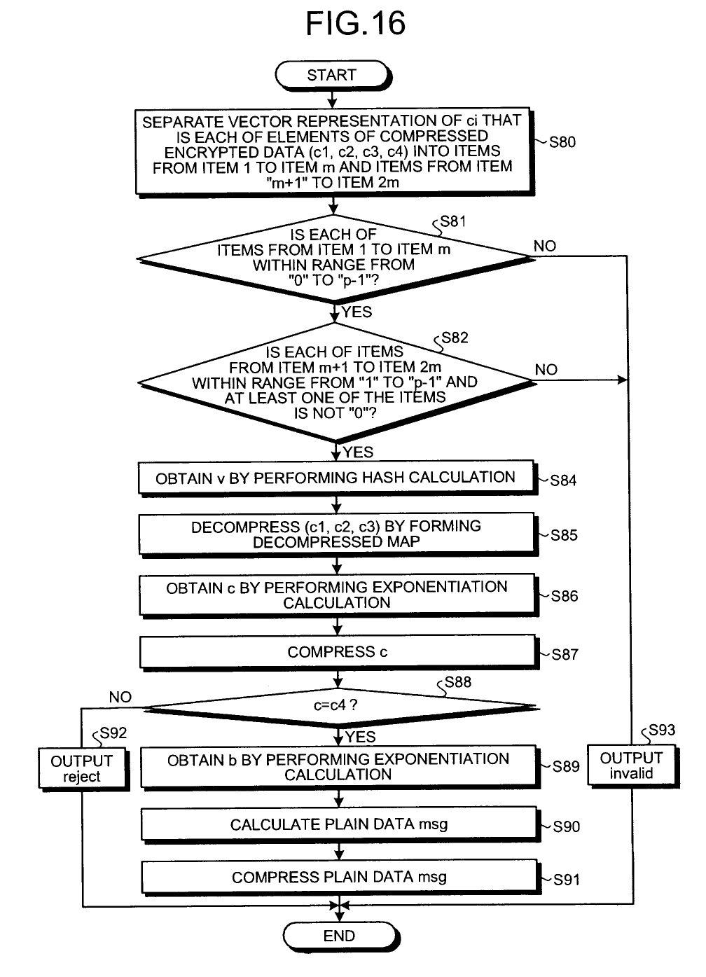

Next, a procedure in the decrypting process performed by the receiving apparatus 400′ according to the sixth embodiment will be explained, with reference to FIG. 16. The processes performed at Steps S80 through S82 are the same as the processes according to the fifth embodiment. In the case where the result of the judging process at Step S82 is in the affirmative, the decrypting apparatus 403′ does not perform the process at Step S83 but performs the processes at Step S84 and thereafter.

With the arrangements described above, with respect to the torus in F_{p̂(6*m)}, in the case where the plain data is represented by using the affine representation, and the calculation of the encrypted data is performed by using the projection representation, if the order of the torus in F_{p̂(6*m)} is a prime number, it is possible to make the processing load lighter than in the case where the order is a composite number. The reason is that, during the verification process to judge whether the input is a member of a proper group, it is not necessary to judge whether the condition (C5) is satisfied and whether the condition (F5) is satisfied.

The present invention is not limited to the exemplary embodiments described above. During the actual implementation of the present invention, it is possible to embody the invention while modifying the constituent elements without departing from the gist of the invention. In addition, various inventions may be formed by combining, as necessary, two or more of the constituent elements described in the exemplary embodiments above. For example, one or more of the constituent elements described in the exemplary embodiments may be omitted. Further, one or more of the constituent elements presented in mutually different exemplary embodiments may be used in combination, as necessary. Furthermore, it is possible to apply any of the various modifications described below to the present invention.

In any of the exemplary embodiments described above, another arrangement is acceptable in which the various types of programs executed by the transmitting apparatus 300 are stored in a computer connected to a network such as the Internet so that the programs are provided as being downloaded via the network. Yet another arrangement is also acceptable in which the various types of programs are provided as being recorded on a computer-readable recording medium such as a Compact Disk Read-Only Memory (CD-ROM), a flexible disk (FD), a Compact Disk Recordable (CD-R), or a Digital Versatile Disk (DVD), in a file that is in an installable format or in an executable format. The same applies to the various types of programs that are executed by the receiving apparatus 400.

In the first to the third embodiments described above, the encrypting apparatus 301 and the compressing apparatus 302 are realized when the CPU of the transmitting apparatus 300 executes the various types of programs stored in the storage devices and the external storage devices; however, the present invention is not limited to this example. Another arrangement is acceptable in which the encrypting apparatus 301 and the compressing apparatus 302 are configured with hardware. The same applies to the decrypting apparatus 401 and the decompressing apparatus 402. Further, the same applies to the encrypting apparatuses 303 and 303′ and the decrypting apparatuses 403 and 403′ according to the fifth and the sixth embodiments.

In the first embodiment described above, the calculations performed by the encrypting apparatus 301 and the decrypting process performed by the decrypting apparatus 401 are realized through the calculations that use the extension field representations. However, another arrangement is acceptable in which the calculations and the decrypting process are realized with projection representations. In this situation, the encrypting apparatus 301 verifies whether the input plain data msg is a member of a proper group by judging whether the plain data msg satisfies both of the conditions (A1) and (B1′) shown below. The condition (A1) is the same as the one used in the first embodiment.
(A1): The plain data msg is contained in {0, . . . , p−1}̂(6*m);
(B1′): msĝ(q)=1 is satisfied in the calculation using the projection representation.

In the case where the result of the verification process is in the affirmative, the encrypting apparatus 301 obtains the elements c1, c2, c3, and c4 by performing a multiplication with the projection representation. Also, in the same manner as described in the first embodiment, the compressing apparatus 302 compresses the encrypted data by forming a compression map and thus generates the compressed encrypted data (c1, c2, c3, c4). In the present example, however, the compressing apparatus 302 forms the compression map by performing a calculation that uses a projection representation of the affine representation F_{p̂m}×F_{p̂m}̂*.

Further, the decompressing apparatus 402 verifies whether each of the elements of the compressed encrypted data (c1, c2, c3, c4) is a member of a proper group by judging whether each element ci of the compressed encrypted data satisfies both of the conditions (C1) and (D1′) that are shown below. The condition (C1) is the same as the one used in the first embodiment.
(C1): The element ci is contained in F_{p̂m}×F_{p̂m}̂*;
(D1′): cî(q)=1 is satisfied in the calculation using the extension field representation.

In the case where the result of the verification process is in the affirmative, the decompressing apparatus 402 obtains the encrypted data (c1, c2, c3, c4) by decompressing each of the elements of the compressed encrypted data from the affine representation into the extension field representation, by forming a decompression map.

As described above, even in the case where the plain data is represented by using the extension field representation, and the calculation of the encrypted data is performed by using the projection representation, it is possible to omit the redundant process during the verification process to judge whether the plain data or the compressed encrypted data that has been input is a member of a proper group. In particular, it is possible to perform the verification process using the condition (D1′) before the projection representation is mapped into the extension field representation. Thus, it is possible to detect improper encrypted data more efficiently than in the case where the verification process is performed by using the condition (D1).

In the second embodiment described above, the calculations performed by the encrypting apparatus 301 and the decrypting process performed by the decrypting apparatus 401 are realized with the extension field representations. However, another arrangement is acceptable in which the calculations and the decrypting process are realized with projection representations. In this situation, the encrypting apparatus 301 verifies whether the input plain data msg is a member of a proper group by judging whether the plain data msg satisfies the condition (B2′) shown below:
(B2′): msĝ{p̂(2*m)−p̂(m)+1}=1 is satisfied in the calculation using the projection representation.

In the case where the result of the verification process is in the affirmative, the encrypting apparatus 301 performs a multiplication with the projection representation and obtains the elements c1, c2, c3, and c4. Further, in the same manner as described in the first embodiment, the compressing apparatus 302 compresses the encrypted data by forming a compression map and thus generates the compressed encrypted data (c1, c2, c3, c4). In the present example, however, the compressing apparatus 302 forms the compression map by performing a calculation that uses a projection representation of the affine representation F_{p̂m}×F_{p̂m}̂*. The verification process performed by the decompressing apparatus 402 is the same as the one described in the second embodiment.

With the arrangements described above, even in the case where the plain data is represented by using the extension field representation, and the calculation of the encrypted data is performed by using the projection representation, it is possible to omit the redundant process during the verification process to judge whether the plain data or the compressed encrypted data that has been input is a member of a proper group.

In the third embodiment described above, the calculations performed by the encrypting apparatus 301 and the decrypting process performed by the decrypting apparatus 401 are realized with the projection representations. However, another arrangement is acceptable in which the calculations and the decrypting process are realized with extension field representations. In this situation, the encrypting apparatus 301 verifies whether the input plain data msg is a member of a proper group by judging whether the plain data msg satisfies both of the conditions (A3) and (B3′) shown below. The condition (A3) is the same as the one used in the third embodiment.
(A3): The plain data msg is contained in F_{p̂m}×F_{p̂m}̂*;
(B3′): msĝ(q)=1 is satisfied in the calculation using the extension field representation.

In the case where the result of the verification process is in the affirmative, the encrypting apparatus 301 performs a multiplication with the extension field representation and obtains the elements c1, c2, c3, and c4. Further, the compressing apparatus 302 compresses the elements c1, c2, c3, and c4 by forming a compression map and outputs the compressed encrypted data (c1, c2, c3, c4).

Further, the decompressing apparatus 402 verifies whether each of the elements of the compressed encrypted data (c1, c2, c3, c4) is a member of a proper group by judging whether each element ci of the compressed encrypted data satisfies both of the conditions (C3) and (D3′) shown below. The condition (C3) is the same as the one used in the third embodiment.
(C3): The element ci is contained in F_{p̂m}×F_{p̂m}̂*;
(D3′): cî{q}=1 is satisfied in a calculation using the extension field representation.

In the case where the result of the verification process is in the affirmative, the decompressing apparatus 402 obtains the encrypted data (c1, c2, c3, c4) by decompressing each of the elements of the compressed encrypted data from the affine representation by forming a decompression map.

As described above, even in the case where the plain data is represented by using the affine representation and the calculation of the encrypted data is performed by using the extension field representation, it is possible to omit the redundant process during the verification process to judge whether the plain data or the compressed encrypted data that has been input is a member of a proper group.

In the fourth embodiment described above, the calculations performed by the encrypting apparatus 301 and the decrypting process performed by the decrypting apparatus 401 are realized with the projection field representations. However, another arrangement is acceptable in which the calculations and the decrypting process are realized with extension field representations. In this situation, the encrypting apparatus 301 verifies whether the input plain data msg is a member of a proper group by judging whether the condition (A3) shown above is satisfied. On the other hand, the decompressing apparatus 402 verifies whether each of the elements of the compressed encrypted data (c1, c2, c3, c4) is a member of a proper group by judging whether the condition (C3) shown above is satisfied.

As described above, even in the case where the plain data is represented by using the affine representation, and the calculation of the encrypted data is performed by using the extension field representation, it is possible to omit the redundant process during the verification process to judge whether the plain data or the compressed encrypted data that has been input is a member of a proper group.

In the first embodiment or the modification examples described above, the decompressing apparatus 402 included in the receiving apparatus 400 decompresses each of the elements in the compressed encrypted data from the affine representation into the extension field representation by forming the decompression map; however, another arrangement is acceptable in which the decompressing apparatus 402 uses the extension field representation that is obtained during the verification processes using the condition (D1) or the condition (D3′).

In the third embodiment or the modification examples described above, the decompressing apparatus 402 included in the receiving apparatus 400 decompresses each of the elements of the compressed encrypted data from the affine representation into the extension field representation by forming the decompression map; however, another arrangement is acceptable in which the decompressing apparatus 402 decompresses the projection representation obtained during the verification process using the condition (D1′) into an extension field representation.

In the third embodiment, the encrypting apparatus 301 obtains the encrypted data that is represented with the tuple of elements ci in the projection representation by performing the calculation with the projection representation based on the plain data msg that is represented by using the affine representation F_{p̂m}×F_{p̂m}̂*; however, another arrangement is acceptable in which the encrypting apparatus 301 obtains the encrypted data that is represented with the tuple of elements ci in the projection representation by performing a calculation with a projection representation based on the plain data msg that is represented by using the projection representation used in the verification process with the condition (B3).

In the modification example described above, the encrypting apparatus 301 obtains the encrypted data that is represented with the tuple of elements ci in the projection representation by performing the calculation with the projection representation based on the plain data msg that is represented by using the extension field representation; however, another arrangement is acceptable in which the encrypting apparatus 301 obtains the encrypted data that is represented with the tuple of elements ci in the projection representation by performing a calculation with a projection representation based on the plain data msg that is represented by using the projection representation used in the verification process with the condition (B1′).

In the modification example described above, the encrypting apparatus 301 obtains the encrypted data that is represented with the tuple of elements ci in the extension field representation by performing the calculation with the extension field representation based on the plain data msg that is represented by using the affine representation F_{p̂m}×F_{p̂m}̂*; however, another arrangement is acceptable in which the encrypting apparatus 301 obtains the encrypted data that is represented with the tuple of elements ci in the extension field representation by performing a calculation with an extension field presentation based on the plain data msg that is represented by using the extension field representation used in the verification process with the condition (B3′).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A decrypting apparatus that decrypts encrypted data that is encrypted first data containing plain data, the encrypted data being represented by using an affine representation F_{p̂m}×F_{p̂m}̂* (where p: a prime number; m: a natural number; and ̂: exponentiation), the apparatus comprising:
an obtaining unit that obtains encrypted data represented in a vector format and a secret key corresponding to a public key;
a judging unit that judges whether a vector component contained in the encrypted data is the affine representation F_{p̂m}×F_{p̂m}̂*;
a decompressing unit that, based on a result of the judging by the judging unit, maps the vector component onto each of members of an algebraic torus by forming a decompression map; and
a decrypting unit that decrypts the encrypted data mapped onto each of the members of the algebraic torus, by using the secret key, therefore obtains the plain data.

2. The apparatus according to claim 1, wherein
an order of the algebraic torus is a prime number, and
the decompressing unit maps the vector component that is an element of an affine space F_{p̂m}×F_{p̂m}̂* onto each of the members of the algebraic torus by forming the decompression map, when the result of the judging by the judging unit is in affirmative.

3. The apparatus according to claim 1, wherein
an order of the algebraic torus is a composite number,
the judging unit includes
an affine representation judging unit that judges whether the vector component is the affine representation F_{p̂m}×F_{p̂m}̂*; and
a subgroup member judging unit that judges whether the vector component is a member of a prime-number order subgroup G that is a subgroup of order q, by mapping the vector component into a projection representation and judging whether ĉ(q)=1 is satisfied in a calculation with the projection representation, when a result of the judging by the affine representation judging unit is in affirmative, and
the decompressing unit maps the vector component onto each of the members of the algebraic torus by forming the decompression map, when a result of the judging by the subgroup member judging unit is in affirmative.

4. The apparatus according to claim 1, wherein
an order of the algebraic torus is a composite number,
the judging unit includes
an affine representation judging unit that judges whether the vector component is the affine representation F_{p̂m}×F_{p̂m}̂*, and
a subgroup member judging unit that judges whether the vector component is a member of a prime-number order subgroup G that is a subgroup of order q, by mapping the vector component into an extension field representation and judging whether ĉ(q)=1 is satisfied in a calculation with the extension field representation, when a result of the judging by the affine representation judging unit is in affirmative, and
the decompressing unit maps the vector component onto each of the members of the algebraic torus by forming the decompression map, when a result of the judging by the subgroup member judging unit is in affirmative.

5. The apparatus according to claim 3, wherein, when the result of the judging by the subgroup member judging unit is in affirmative, the decompressing unit maps the vector component onto each of the members of the algebraic torus by using the projection representation obtained by the subgroup member judging unit when mapping the vector component.

6. The apparatus according to claim 4, wherein, when the result of the judging by the subgroup member judging unit is in affirmative, the decompressing unit maps the vector component onto each of the members of the algebraic torus by using a representation obtained by the subgroup member judging unit when mapping the vector component.

7. The apparatus according to claim 1, wherein the decrypting unit decrypts the encrypted data that is represented by using an affine representation, by using the secret key, therefore obtains the plain data.

8. The apparatus according to claim 1, wherein the decrypting unit decrypts the encrypted data that is represented by using an extension field representation, by using the secret key, therefore obtains the plain data.

9. An encrypting apparatus that encrypts plain data msg that is a member of an algebraic torus in a degree six extension field of F_{p̂m} and is represented by using an affine representation F_{p̂m}×F_{p̂m}̂* (where p: a prime number; and m: a natural number), the apparatus comprising:
an obtaining unit that obtains the plain data msg and a public key, the plain data msg being a target of an encrypting process and being represented in a vector format;
a judging unit that judges whether a vector component contained in the plain data msg is the affine representation F_{p̂m}×F_{p̂m}̂*; and
an encrypting unit that, based on a result of the judging by the judging unit, encrypts the plain data msg by using the public key, and obtains encrypted data c that is represented by using a tuple of elements of an affine space F_{p̂m}×F_{p̂m}̂*.

10. The apparatus according to claim 9, wherein
an order of the algebraic torus is a prime number, and
the encrypting unit encrypts the plain data msg by using the public key, and obtains the encrypted data c that is represented by using the tuple of the elements of the affine space F_{p̂m}×F_{p̂m}̂*, when the result of the judging by the judging unit is in affirmative.

11. The apparatus according to claim 9, wherein
an order of the algebraic torus is a composite number,
the judging unit includes
an affine representation judging unit that judges whether the vector component is the affine representation F_{p̂m}×F_{p̂m}̂*, and
a subgroup member judging unit that judges whether the vector component is a member of a prime-number order subgroup G that is a subgroup of order q, by mapping the affine representation into a projection representation, mapping the vector component into a projection representation, and judging whether msĝ(q)=1 is satisfied in a calculation with the projection representation, when a result of the judging by the affine representation judging unit is in affirmative, and
the encrypting unit encrypts the plain data msg by using the public key and obtains the encrypted data c that is represented by using the tuple of the elements of the affine space F_{p̂m}×F_{p̂m}̂*, when a result of the judging by the subgroup member judging unit is in affirmative.

12. The apparatus according to claim 9, wherein
an order of the algebraic torus is a composite number,
the judging unit includes
an affine representation judging unit that judges whether the vector component is the affine representation F_{p̂m}×F_{p̂m}̂*, and
a subgroup member judging unit that judges whether the vector component is a member of a prime-number order subgroup G that is a subgroup of order q, by mapping the affine representation into an extension field representation, mapping the vector component into an extension field representation, and judging whether msĝ(q)=1 is satisfied in a calculation with the projection representation, when a result of the judging by the affine representation judging unit is in affirmative, and
the encrypting unit encrypts the plain data msg by using the public key and obtains the encrypted data c that is represented by using the tuple of the elements of the affine space F_{p̂m}×F_{p̂m}̂*, when a result of the judging by the subgroup member judging unit is in affirmative.

13. The apparatus according to claim 11, wherein the encrypting unit encrypts the plain data msg by using a representation obtained by the subgroup member judging unit when mapping the vector component into the projection representation, and obtains the encrypted data c that is represented by using the tuple of the elements of the affine space F_{p̂m}×F_{p̂m}̂*, when the result of the judging by the subgroup member judging unit is in affirmative.

14. The apparatus according to claim 12, wherein the encrypting unit encrypts the plain data msg by using a representation obtained by the subgroup member judging unit when mapping the vector component into the extension field representation, and obtains the encrypted data c that is represented by using the tuple of the elements of the affine space F_{p̂m}×F_{p̂m}̂*, when the result of the judging by the subgroup member judging unit is in affirmative.

15. The apparatus according to claim 9, wherein
the obtaining unit obtains the plain data msg, an order q of a group Ĝ for which an encryption is defined in the algebraic torus, an generator g of the group Ĝ, and a public key that contains at least one member of the group Ĝ, and
the encrypting unit encrypts the plain data msg by performing a calculation while using a random number, the plain data msg, the generator g, and the at least one member of the group Ĝ, and obtains the encrypted data c that is represented by using the tuple of the elements of the affine space F_{p̂m}×F_{p̂m}̂*, when the result of the judging by the judging unit is in affirmative.

16. An encrypting apparatus that encrypts plain data msg that is a member of an algebraic torus in a degree six extension field of F_{p̂m} (where ̂ denotes exponentiation) and is represented by using an extension field representation {{0, . . . , p−1}̂(6*m)} (where p: a prime number; and m: a natural number), the apparatus comprising:
an obtaining unit that obtains the plain data msg and a public key, the plain data msg being a target of an encrypting process;
a judging unit that judges whether the plain data msg is a member of the algebraic torus by judging whether the plain data msg is contained in {0, . . . , p−1}̂(6*m) and whether msĝ(p̂(2*m)−p̂(m)+1)=1 is satisfied;
an encrypting unit that, based on a result of the judging by the judging unit, encrypts the plain data msg by using the public key, and obtains encrypted data c that is represented by using a tuple of members of the algebraic torus; and
a compressing unit that maps each of members of the encrypted data c into an affine representation F_{p̂m}×F_{p̂m}̂* by forming a compression map.

17. The apparatus according to claim 16, wherein
an order of the algebraic torus is a prime number, and
the encrypting unit encrypts the plain data msg by using the public key, and obtains the encrypted data c that is represented by using the tuple of members of the algebraic torus, when the result of the judging by the judging unit is in affirmative.

18. The apparatus according to claim 16, wherein
an order of the algebraic torus is a composite number,
the judging unit includes
an extension-field member judging unit that judges whether the plain data msg is a member of the degree six extension field by judging whether the plain data msg is contained in {0, . . . , p−1}̂(6*m), and
a subgroup member judging unit that judges whether the plain data msg is a member of a prime-number order subgroup G that is a subgroup of order q of an algebraic torus, by judging whether msĝ(q)=1 is satisfied in a calculation in a degree six extension field of F_{p̂m}, while “p̂(2*m)−p̂(m)+1” is divisible by q, when a result of the judging by the extension-field member judging unit is in affirmative, and
the encrypting unit encrypts the plain data msg by using the public key, and obtains the encrypted data c that is represented by using the tuple of the members of the algebraic torus, when a result of the judging by the subgroup member judging unit is in affirmative.

19. The apparatus according to claim 16, wherein
an order of the algebraic torus is a composite number,
the judging unit includes
an extension-field member judging unit that judges whether the plain data msg is a member of the degree six extension field by judging whether the plain data msg is contained in {0, . . . , p−1}̂(6*m), and
a subgroup member judging unit that judges whether the plain data msg is a member of a prime-number order subgroup G that is a subgroup of order q of an algebraic torus, by judging whether msĝ(q)=1 is satisfied in a calculation with the projection representation, while “p̂(2*m)−p̂(m)+1” is divisible by a prime number q, when a result of the judging by the extension-field member judging unit is in affirmative, and
the encrypting unit encrypts the plain data msg by using the public key, and obtains the encrypted data c that is represented by using the tuple of the members of the algebraic torus, when a result of the judging by the subgroup member judging unit is in affirmative.

20. The apparatus according to claim 19, wherein, when the result of the judging by the subgroup member judging unit is in affirmative, the encrypting unit encrypts the plain data msg by using a representation obtained by the subgroup member judging unit when mapping the vector component into the projection representation, and obtains the encrypted data c that is represented by using the tuple of the members of the algebraic torus.

21. The apparatus according to claim 16, wherein
the obtaining unit obtains the plain data msg, an order q of a group Ĝ for which an encryption is defined in the algebraic torus, an generator g of the group Ĝ, and a public key that contains at least one member of the group Ĝ, and
the encrypting unit encrypts the plain data msg by performing a calculation while using a random number, the plain data msg, the generator g, and the at least one member of the group Ĝ, and obtains the encrypted data c that is represented by using the tuple of the members of the algebraic torus, when the result of the judging by the judging unit is in affirmative.
